(19) United States
(12) Patent Application Publication
(10) Pub. No.: US 2024/0365824 A1
(43) Pub. Date: Nov. 7, 2024

(54) TOFU PRODUCT PRODUCTION DEVICE

(71) Applicant: TAKAI TOFU & SOYMILK EQUIPMENT CO., Ishikawa (JP)

(72) Inventors: Toichiro TAKAI, Ishikawa (JP); Toru AWAZU, Ishikawa (JP); Motonari AMANO, Ishikawa (JP); Makoto JIOU, Ishikawa (JP); Yusuke SETO, Ishikawa (JP); Toshiki MATSUMOTO, Ishikawa (JP); Katsuya TOKINAGA, Ishikawa (JP); Riku YOSHIDA, Ishikawa (JP)

(73) Assignee: TAKAI TOFU & SOYMILK EQUIPMENT CO., Ishikawa (JP)

(21) Appl. No.: 18/556,652

(22) PCT Filed: Jun. 20, 2022
(86) PCT No.: PCT/JP2022/024568

§ 371 Date: Oct. 20, 2023

(30) Foreign Application Priority Data
Jun. 21, 2021 (JP) 2021-102657
Dec. 1, 2021 (JP) 2021-195527
Jan. 31, 2022 (JP) 2022-013701

(51) Int. Cl. A23L 11/45; A23L 3/00

(52) U.S. Cl. CPC A23L 11/45; A23L 3/001

(57) ABSTRACT

A tofu product production device includes a grinding device that grinds raw soybeans to obtain ground soybeans; an immersion device that immerses the ground soybeans in water to obtain swollen soybeans swollen to at least 1.2 to 2.4 times; and a crushing device that crushes the swollen soybeans to obtain raw soybean paste. The ground soybeans are immersed for a short period of time in the immersion device.

### TECHNICAL FIELD

The present invention relates to a tofu product production device for producing tofu products such as tofu, deep-fried tofu, and soy milk.

### BACKGROUND ART

Tofu, which is a tofu product, is generally produced by the process described in Patent Literature 1. That is, after immersing raw soybeans in water for about 20 hours, the soybeans are finely pulverized with a pulverizer while adding ground water to obtain raw soybean paste. Next, the raw soybean paste is boiled to make paste, and the paste is separated into soy milk and bean curd refuse. Next, after measuring the pH of the separated soy milk, the soy milk is stirred while being deaerated to remove the air contained in the soy milk. After that, the soy milk is cooled, a coagulant is added thereto, and a predetermined amount of the soy milk is filled in a container and packaged. Then, the soy milk is heated in a state filled in a container to be thermally coagulated and sterilized, and then cooled to a water temperature to produce silken tofu.

### CITATION LIST

### Patent Literature

Patent Literature 1: JPH05-3761A

### SUMMARY OF INVENTION

### Technical Problem

In the production process in the related art as described above, the raw soybeans are immersed in water for a long period of time of about 20 hours, the production efficiency is poor, and further, when there is a sudden order, it is not possible to respond thereto. In addition, a large space for immersing the raw soybeans to be produced in one day is required.

The present invention is made in view of the above problems, and an object thereof is to provide a space-saving tofu product production device capable of efficiently immersing soybeans in a short period of time.

### Solution to Problem

The above object of the present invention is achieved by the following configurations.

(1) A tofu product production device including: a grinding device that grinds raw soybeans to obtain ground soybeans; an immersion device that immerses the ground soybeans in water to obtain swollen soybeans swollen to at least 1.2 to 2.4 times; and a crushing device that crushes the swollen soybeans to obtain raw soybean paste, in which the ground soybeans are immersed for a short period of time in the immersion device.

(2) The tofu product production device according to (1), in which the grinding device is provided with one or more water adding devices for grinding the raw soybeans while water is added.

(3) The tofu product production device according to (1) or (2), in which the immersion device is provided with at least one water adding device that adds water according to a swelling speed of the ground soybeans.

(4) The tofu product production device according to any one of (1) to (3), in which the immersion device has a conveyance channel for conveying the ground soybeans while the ground soybeans are immersed in water, and a cross-sectional area of the conveyance channel increases in accordance with volumetric expansion due to swelling of the ground soybeans.

(5) The tofu product production device according to any one of (1) to (4), in which the immersion device has a conveyance channel for conveying the ground soybeans while the ground soybeans are immersed in water, and the conveyance channel conveys the ground soybeans from a lower part to an upper part in a direction of gravity.

(6) The tofu product production device according to any one of (1) to (5), in which the immersion device includes a pipe configuring a conveyance channel for conveying the ground soybeans while the ground soybeans are immersed in water, and a pump that supplies the ground soybeans and the water toward the pipe.

(7) The tofu product production device according to (6), in which the pipe is formed such that the ground soybean is directed from the lower part to the upper part in the direction of gravity.

(8) The tofu product production device according to (6) or (7), in which the pipe has a folded portion with an angle of 180 degrees or less.

(9) The tofu product production device according to (8), in which the folded portion of the pipe is provided with an air blower that blows air toward an inside of the pipe.

(10) The tofu product production device according to any one of (6) to (9), in which the pipe is provided with a heating device that heats the water.

(11) The tofu product production device according to any one of (6) to (10), in which a static mixer is provided in the pipe.

(12) The tofu product production device according to any one of (1) to (5), in which the immersion device includes a trough configuring a conveyance channel for conveying the ground soybeans while the ground soybeans are immersed in water, and a screw provided inside the trough, and the ground soybeans and water supplied into the trough travel through the inside of the trough as the screw rotates.

(13) The tofu product production device according to (12), in which the trough is formed such that the ground soybean is directed from the lower part to the upper part in the direction of gravity.

(14) The tofu product production device according to (12) or (13), in which one or a plurality of the screws are provided inside the trough.

(15) The tofu product production device according to any one of (12) to (14), in which the immersion device includes a plurality of trough/screw devices each having the trough and the screw, the plurality of trough/screw devices are provided in multiple stages in an up-down direction in the direction of gravity, and the ground soybeans and water are conveyed from the trough/screw device in a lower stage to the trough/screw device in an upper stage.

(16) The tofu product production device according to any one of (12) to (15), in which the immersion device includes an air blowing device that blows off the ground soybeans adhering to the screw with air.

(17) The tofu product production device according to any one of (12) to (16), further including: a rotary positive displacement single shaft eccentric screw pump to which the ground soybeans obtained by the grinding device and water are supplied, in which the rotary positive displacement single shaft eccentric screw pump supplies the ground soybeans and the water to the immersion device while mixing the ground soybeans and the water.

(18) The tofu product production device according to any one of (1) to (3), in which the immersion device is a batch type continuous immersion device having a plurality of immersion tanks for immersing the ground soybeans in water.

(19) The tofu product production device according to (18), in which the immersion device includes a housing, and a plurality of wall members spaced apart from each other within the housing, the plurality of immersion tanks are formed between the wall members adjacent to each other, and the plurality of immersion tanks immerse the ground soybeans in water while conveying the ground soybeans as the plurality of wall members move.

(20) A tofu product production method including: a grinding process of grinding raw soybeans to obtain ground soybeans; an immersion process of immersing the ground soybeans in water to obtain swollen soybeans swollen to at least 1.2 to 2.4 times; and a crushing process of crushing the swollen soybeans to obtain raw soybean paste, in which the ground soybeans are immersed for a short period of time in the immersion process.

(21) The tofu product production method according to (20), in which, in the grinding process, the raw soybeans are ground while water is added.

(22) The tofu product production method according to (20) or (21), in which, as the raw soybeans, those that are washed or sterilized, or those that pass through a washing/sterilization device are used.

(23) The tofu product production method according to any one of (20) to (22), in which, as the raw soybeans, those in a wet surface state are used.

(24) The tofu product production method according to any one of (20) to (23), in which all or part of seed coats generated when the raw soybeans are ground in the grinding process are used.

### Advantageous Effects of Invention

According to the present invention, a space-saving tofu product production device which can efficiently immerse soybeans in a short period of time can be provided.

### BRIEF DESCRIPTION OF DRAWINGS

FIG. 1 is a flow chart showing a tofu product production process in a tofu product production device of the present invention.

FIG. 2 is a schematic view showing an immersion device of a tofu product production device according to a first embodiment.

FIG. 3 is a schematic view showing an immersion device of a tofu product production device according to a first modification example of the first embodiment.

FIG. 4 is a schematic view showing an immersion device of a tofu product production device according to a second modification example of the first embodiment.

FIG. 5 is a schematic view showing an immersion device of a tofu product production device according to a third modification example of the first embodiment.

FIG. 6 is a schematic view showing an immersion device, a crushing device, and a soy milk production device of a tofu product production device according to a second embodiment.

FIG. 7 is a schematic view showing an immersion device, a crushing device, and a soy milk production device of a tofu product production device according to a third embodiment.

FIG. 8 is a schematic view showing an immersion device of a tofu product production device according to a fourth embodiment.

FIG. 9 is a view showing a trough according to a modification example.

FIG. 10 is a view showing a trough according to a modification example.

FIG. 11 is a view showing a trough according to a modification example.

FIG. 12 is a view showing a trough according to a modification example.

FIG. 13 is a view of a trough according to a modification example, viewed from an axial direction.

FIG. 14 is a schematic view showing an immersion device according to a modification example.

FIG. 15 is a schematic view showing an immersion device of a tofu product production device according to a reference example of the fourth embodiment.

FIG. 16 is a view showing a screw 43 of an immersion device of a tofu product production device according to a modification example of the fourth embodiment.

FIG. 17 is a schematic view showing an immersion device of a tofu product production device according to a modification example of the fourth embodiment.

FIG. 18 is a schematic view showing an immersion device of a tofu product production device according to a fifth embodiment.

FIG. 19 is a schematic view showing an immersion device of a tofu product production device according to a modification example of the fifth embodiment.

FIG. 20 is a schematic view showing an immersion device of a tofu product production device according to a modification example of the fifth embodiment.

FIG. 21 is a perspective view showing an immersion device of a tofu product production device according to a sixth embodiment.

FIG. 22 is a view of the immersion device of the tofu product production device according to the sixth embodiment, viewed from above in a direction of gravity.

### DESCRIPTION OF EMBODIMENTS

Hereinafter, embodiments of a tofu product production device according to the present invention will be described in detail with reference to drawings.

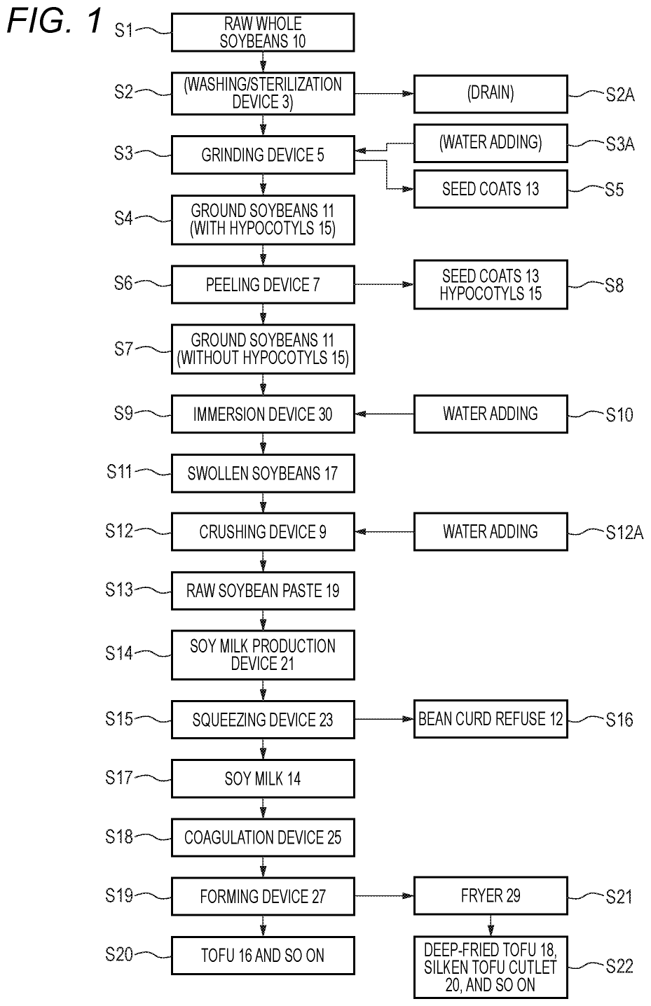

FIG. 1 is a flow chart showing a tofu product production process in the tofu product production device of the present invention. First, with reference to FIG. 1, the outline of the tofu product production process will be described.

As shown in FIG. 1, raw whole soybeans 10 are first sorted (step S1) and supplied to a washing/sterilization device 3, and seed coats 13 on the surface are washed or sterilized (step S2). A method of washing or sterilization is not particularly limited, and water (hot water), bubbling, chemical solution, polishing, air, UV sterilization, ozone, superheated vapor, dry heat (hot air), and the like may be adopted regardless of a dry method or a wet method. Although it is preferable to perform washing or sterilization at least once in step S2, washing or sterilization may be omitted as necessary. In addition, step S2 may also be omitted when the raw whole soybeans 10 are washed or sterilized at the time of purchase. Also, the water used in the washing/sterilization device 3 may be drained (step S2A).

Next, a grinding device 5 coarsely grinds the washed and sterilized whole soybeans by the dry method or the wet method (step S3) to obtain ground soybeans 11 (step S4). The volume of one grain of the ground soybean 11 is, for example, ½ to 1/64, and preferably ½ to 1/32, of the volume of one grain of the raw whole soybean 10. It is to be noted that the ground soybeans 11 obtained in step S4 have a hypocotyl 15.

The raw whole soybeans 10 are preferably dry, but depending on the method of washing and sterilization, the seed coat 13 on the surface gets wet, and thus the whole soybeans that are semi-dry (only the surface of the soybean is wet) may be used.

Alternatively, a water adding device may be provided in the grinding device 5 to obtain the ground soybeans 11 by the wet method while water is added (step S3A).

When the tofu product production device is equipped with a peeling device 7, the ground soybeans 11 are supplied to the peeling device 7 (step S6), and when the tofu product production device is not equipped with the peeling device 7, steps S6 to S8 are omitted, and the ground soybeans 11 are supplied to an immersion device 30 with the hypocotyls 15 (step S9). In addition, the seed coat 13 peeled off when the raw soybean is ground by the grinding device 5 or the peeling device 7 may or may not be supplied to the peeling device 7 or the immersion device 30 When all the seed coats 13 are supplied, a decrease in yield can be prevented. However, when all the seed coats 13 are supplied, it is preferable to wash and sterilize the seed coats 13 with the washing/sterilization device 3. Since the seed coat 13 of the raw whole soybean 10 is contaminated with dirt such as soil and dust, and various bacteria and spore forming bacteria adhere thereto, when tofu products are produced without washing or sterilization, the shelf life of the tofu products may be shortened or, in the worst case, food poisoning may be caused. When the seed coat 13 is not supplied, the seed coat 13 is discarded or used for another purpose (for example, animal feed) (step S5). The discarded seed coat 13 is preferably 1% or more and 15% or less with respect to the weight of the original raw whole soybeans 10, and when the discarded seed coat 13 exceeds 15%, the yield is remarkably lowered.

When the tofu product production device is equipped with the peeling device 7, following steps S6 to S8 are applied. The ground soybeans 11 supplied to the peeling device 7 in step 6 are supplied to the immersion device 30 in a state where the seed coats 13 and the hypocotyls 15 are removed by the peeling device 7 (step S7). A ratio of the weight of the hypocotyls other than the seed coats 13 removed by the peeling device 7 to the weight of the original raw whole soybeans 10 is preferably 1% or more and 10% or less. When the ratio is less than 1%, the hypocotyl-removing effect decreases, and when the ratio exceeds 10%, the yield decreases, which is not preferable.

The seed coats 13 and the hypocotyls 15 removed by the peeling device 7 are discarded or used for another purpose (for example, animal feed) (step S8). By removing the seed coats 13 and the hypocotyls 15 from the ground soybeans 11 in this manner, it is possible to produce soy milk and tofu products with a refreshing flavor without any unpleasant taste, and furthermore, the number of initial bacteria in the raw soybean paste before heating is reduced, and the shelf life of finished tofu products is improved. In addition, water for washing whole soybeans and water drained after immersion in the related art can also be saved.

In addition to the ground soybeans 11, water is supplied to the immersion device 30 (step S10). In addition, “water” in the specification includes “warm water” that is warmer than room temperature. The temperature of the water to be added into the immersion device 30 is, for example, 20 to 95° C., preferably 30 to 80° C., and more preferably 40 to 70° C. The water quality is not particularly limited, but any fresh water for drinking may be used. The immersion device 30 immerses the ground soybeans 11 in water to obtain swollen soybeans 17 which are at least partially swollen (step S11). The immersion device 30 is preferably of a continuous conveyance type having a conveyance channel for conveying the ground soybeans 11 while the ground soybeans 11 are immersed in water, but may have a part where the ground soybeans 11 are temporarily retained, stopped, or stagnated, may be in a form in which the retention portion may be switched for conveyance, or may be a batch continuous type or an intermittent conveyance type.

In addition, the swollen soybeans 17 include not only the ground soybeans 11 that fully absorb water and are swollen, but also the ground soybeans 11 that absorb a small amount of water and are half-swollen. Specifically, even when a swelling rate of the swollen soybeans 17 is not sufficient, the swelling rate may be 1.2 to 2.4 times when the ground soybeans 11 are set to 1, a swelling rate of 1.3 to 2.3 times is preferable, and a swelling rate of 1.5 to 2.2 times is more preferable. The swollen soybeans 17 may be in a state of partial water absorption and partial swelling, even when the swollen soybeans 17 are not completely swollen. Depending on factors such as a ground grain size distribution, a water temperature, and time, tofu with sufficient hardness can be obtained even when the swollen soybeans 17 partially absorb water

Either the ground soybeans 11 or water may be added into the immersion device 30 first, or may be added at the same time. In any case, the ground soybeans 11 and the water are brought into a fluid state by a stirring device or the like such that lumps and clumps do not occur and the ground soybeans 11 and the water does not adhere to the wall surface of the immersion device 30, and the ground soybeans 11 and the water are added. Regarding the addition of the water into the immersion device 30, a predetermined amount of water necessary for immersing the ground soybeans 11 may be added all at once, gradually, or continuously. In addition, the soy milk concentration can be changed by adjusting the total amount of water added by the immersion device 30 and water adding devices at various locations.

The temperature of the water in the immersion device 30 is, for example, 20 to 95° C., preferably 30 to 80° C., and more preferably 40 to 70° C. The temperature of the water added into the immersion device 30 can be controlled, and the temperature of the water for immersing the ground soybeans 11 in the immersion device 30 can also be controlled. In order to control the temperature (heating, heat retention, cooling) of the water in the immersion device 30, the conveyance channel of the immersion device 30 may be a double pipe, the inside of the conveyance channel may be heated by steam, and a jacket may be disposed around the conveyance channel. When the water temperature in the immersion device 30 is extremely high and the immersing of the ground soybeans 11 is likely to proceed faster than expected, cold water of 0 to 20° C. may be added for cooling. An immersion time of the ground soybeans 11 in the immersion device 30 varies depending on various conditions such as the size (grain size distribution) of the ground soybeans 11 and the water temperature in the immersion device 30, but is, for example, 1 second to 3 hours, preferably 1 minute to 1 hour, and more preferably 1 minute to 30 minutes. More specifically, the immersion time can be set as short as 20 minutes when the water temperature is 30° C., 10 minutes when the water temperature is 40° C., and 5 minutes when the water temperature is 50° C. When the ground soybeans 11 are immersed too much, the tofu may become soft and give off an oxidized odor, or the tofu may rot and give off a putrified flavor, and thus immersing the ground soybeans 11 for a long period of time is not preferable.

The swollen soybeans 17 obtained by the immersion device 30 are supplied to a crushing device 9 together with the water in the immersion device 30, and are crushed (step S12) while water is further added as appropriate (step 12A), and raw soybean paste 19 is obtained (step S13). The raw soy bean paste 19 may be adjusted to obtain a predetermined soy milk concentration by adding water. The crushing device 9 is, for example, a wet fine pulverizer made of SUS, and a screen mill type or stone mill type device is used.

The raw soybean paste 19 is heated in a soy milk production device 21 to be paste (step S14). Heating is preferably performed under the same or stronger conditions than usual. In a case where whole soybeans are immersed without being ground, when the final product is a tofu product, heating is performed to a final temperature of 100 to 105° C. for 3 to 6 minutes, and when the final product is deep-fried tofu, heating is performed to a final temperature of 95 to 100° C. for 1 to 4 minutes. On the other hand, when the ground soybeans 11 are immersed as in the present invention, the conditions are stronger than when whole soybeans are immersed, that is, the conditions in which heating is performed to a final temperature of 105 to 115° C. for 4 to 15 minutes when the final product is a tofu product, and heating is performed to a final temperature of 100 to 110° C. for 2 to 10 minutes when the final product is deep-fried tofu, are preferable. When producing deep-fried tofu, return water may be added immediately after the raw soybean paste 19 is heated to adjust the concentration and lower the boiling temperature. In heating by direct steam blowing, steam condensed water and drain also correspond to a part of adding water.

Next, the paste is separated into bean curd refuse 12 and soy milk 14 in a squeezing device 23 (steps S16 and S17). The soy milk 14 is hardened by adding a coagulant in a coagulation device 25 (step S18), and is broken after coagulation and ripening, and the soy milk 14 is cut and formed into a desired shape by a cutting device and a forming device 27 (step S19). At this time, “supernatant” that comes out from breaking the tofu is removed and drained. Then, the supernatant is packed or introduced into a frying device. In the case of silken tofu, coagulation and ripening are performed in a mold without holes. The coagulant is not particularly limited, but examples thereof include calcium sulfate (sumashiko), magnesium chloride (bittern), glucono delta-lactone (GDL), calcium chloride, and the like. When making packaged tofu, the soy milk is once cooled, mixed with a coagulant, packaged, and then heated and cooled.

Thereafter, the formed tofu is cut, packaged, and cooled to obtain tofu products such as tofu 16 (step S20). The tofu 16 obtained by immersing the ground soybeans 11 in the above-described production process has a soy milk solid content of 10 to 12% by weight (soy protein is 4 to 5% by weight), and has a hardness of 40 gf/cm² or more immediately after coagulation and ripening, preferably 50 gf/cm² or more, and most preferably 60 gf/cm² or more. In addition. the hardness and water retention properties of the tofu 16 obtained by immersing the ground soybeans 11 in the above-described production process are equivalent to or at least 5% higher, preferably at least 10% higher than those of the tofu obtained by immersing whole soybeans in the usual manner. Further, by frying the formed tofu in a fryer 29 (step S21), deep-fried tofu 18, silken tofu cutlet 20, and the like are obtained (step S22).

The tofu product production device of the present invention produces, through the production process described above, tofu products such as silken tofu, firm tofu, packaged tofu, soy milk (including soy milk for drinking), deep-fried tofu (thin deep-fried tofu, deep-fried tofu pouch), tofu skin, bean curd refuse, silken tofu cutlet, tofu cutlet, thick deep-fried tofu, and deep-fried tofu burger, and particularly, includes the immersion device 30 that immerses the ground soybeans 11 in water to obtain the swollen soybeans 17. Therefore, the immersion device 30 of a tofu product production device according to each embodiment will be described below

### First Embodiment

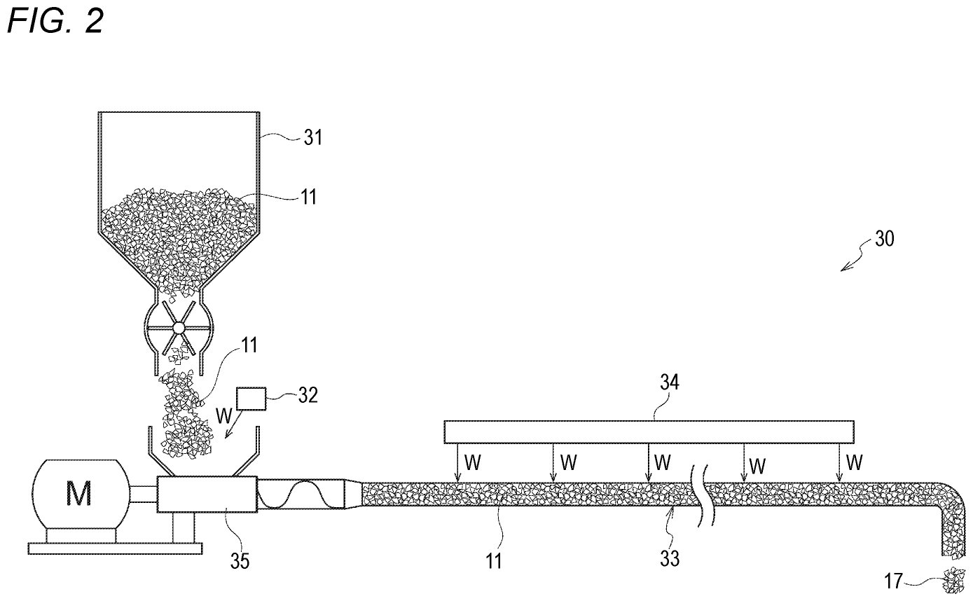

FIG. 2 is a schematic view showing the immersion device 30 of a tofu product production device according to a first embodiment. As described above, the tofu product production device includes the grinding device 5 (refer to FIG. 1) that grinds the raw whole soybeans 10 by a dry method to obtain the ground soybeans 11; the immersion device 30 that immerses the ground soybeans 11 in water W to obtain the swollen soybeans 17 which are at least partially swollen; and the crushing device 9 (refer to FIG. 1) that crushes the swollen soybeans 17 to obtain raw soybean paste.

The immersion device 30 is a continuous immersion device including a hopper 31 into which the ground soybeans 11 obtained by the grinding device 5 are added; a pipe 33 configuring a conveyance channel for conveying the ground soybeans 11 while the ground soybeans 11 are immersed in the water W; and a pump 35 for supplying the ground soybeans 11 quantitatively supplied from the hopper 31 and the water W separately supplied from a water supply device 32 toward the pipe.

In the shown example, the water W supplied from the water supply device 32 to the pump 35 is warm water, and the temperature thereof is preferably 20 to 95° C., and more preferably 30 to 70° C. The pump 35 is a rotary positive displacement single shaft eccentric screw pump, and for example, Mohno Pump (registered trademark) can be applied. The pump 35 is driven by a motor M, and supplies the ground soybeans Il and the water W to the pipe 33 while mixing the ground soybeans 11 and the water W. In this manner, by applying the rotary positive displacement single shaft eccentric screw pump as the pump 35, there is a first-in first-out effect. The pump 35 may be a positive displacement pump capable of feeding solid and liquid, and a rotary pump, a plunger pump, a diaphragm pump, a piston pump, or the like can be adopted as appropriate. A suction-side hopper may be provided with the stirring device to prevent solid-liquid separation.

The pipe 33 has a cylindrical shape, and a cross-sectional area thereof is constant at any position in a conveying direction. The pipe 33 is provided with a water adding device 34 that appropriately gradually adds the water W according to a swelling speed (water absorption rate, water absorption state) of the ground soybeans 11. The water adding device 34 is, for example, a sprinkler pipe extending parallel to the pipe 33, and supplies the water W to a plurality of locations of the pipe 33 in the conveying direction such that the swelling speed of the ground soybeans 11 is maintained within a desired range. In the shown example, the water W from the water adding device 34 is supplied into the pipe 33 at regular intervals in the conveying direction. The temperature of the water W supplied by the water adding device 34 is preferably 20 to 95° C., more preferably 30 to 80° C., and even more preferably 40 to 70° C. A heat retaining means (not shown) may be provided around the pipe 33, and the temperature inside the pipe 33 can be kept constant by retaining the temperature within the above-described range by the heat retaining means.

When a predetermined amount of the water W necessary for immersing the ground soybeans 11 is added all at once from the water supply device 32 to the pump 35, there is a concern that, while the amount of water in the pipe 33 increases and only the water is conveyed.

the ground soybeans 11 sink in a large amount of water (solid-liquid separation occurs and a predetermined water content is maintained) and are not conveyed. Therefore, when the water adding device 34 is provided as in this example, a predetermined amount of water W necessary for immersing the ground soybeans 11 may not be added all at once from the water supply device 32 to the pump 35, and the water W added from the water supply device 32 to the pump 35 may be gradually added in the middle of the conveyance channel (pipe 33) by the water adding device 34 as a part of the above-described predetermined amount. In this case, the ratio of the amount of water between the water W supplied from the water supply device 32 to the pump 35 and the total amount of the water W added to the pipe 33 from the water adding device 34 is preferably 5:5, and more preferably 4:6. Further, the water W added to the pipe 33 from the water adding device 34 may be changed in temperature and amount of water depending on the position thereof.

The swelling speed of the ground soybeans 11 varies depending on factors such as a ground grain size distribution, a water temperature, and time. Therefore, the amount of water added by the water adding device 34 may be the amount of water added corresponding to the target soy milk concentration by adding water that exceeds the water absorption speed (water absorption curve) of the ground soybeans 11, but the requirements are that there is no separation of the water W and the ground soybeans 11 during conveyance, that the physical properties of the solid-liquid mixture do not change much, and that first-in first-out can be performed without changing the ratio of the solid-liquid mixture. Therefore, considering the water absorption amount of the ground soybeans 11, the amount of water that fills the gaps between the grains of the ground soybeans 11, and the minimum amount of water that allows the ground soybeans 11 to have a certain fluidity, the amount of water added is determined by the water adding device 34. Water for concentration adjustment is preferably added separately in the process from the outlet of the immersion device 30 to the crushing device 9 or the soy milk production device 21. When the product is deep-fried tofu, return water (so-called surprise water, which is also a part of adding water to adjust the concentration) is added after a heating process is completed.

The ground soybeans 11 immersed in water while being conveyed in the pipe 33 become the swollen soybeans 17 which are at least partially swollen, and the swollen soybeans 17 are fed to the crushing device 9 (refer to FIG. 1) together with the water used for immersion.

Since soybean solids flow out more or less from the water used for immersion in the immersion device 30, it is preferable to use the entire amount of the water as production water without discarding the water. In addition, it is important that the raw whole soybeans 10 are subjected to immersion treatment, crushing treatment, and heat treatment immediately after being ground by the grinding device 5. When one day or more elapses from a grinding process to the heating process, the oxidation of soybean components and enzymatic reactions proceed, giving off a foul odor and softening the tofu. It is preferable to complete the heat treatment within a short period of time (for example, within one day, preferably within 1 hour, and more preferably within 15 minutes) from the grinding process. In addition, the ground soybeans are oxidized by air, and when the ground soybeans are immersed in water at 40° C. or higher, decomposition reactions and oxidation reactions by endogenous enzymes occur rapidly, and eluted components and various bacteria such as soil bacteria actively grow and putrefaction accelerates.

According to the tofu product production device of the present embodiment, the immersion device 30 that immerses the ground soybeans 11 obtained by grinding the raw whole soybeans 10 in advance in water to obtain the swollen soybeans 17 which are at least partially swollen, is provided, and thus, an immersion process can be completed in a short period of time, and productivity can be improved. Therefore, unlike the related art, it is no longer necessary to perform forecast production such as immersion of whole soybeans in advance from the previous day according to the next day's production amount, and production can be made according to urgent orders on the day.

Further, since the pipe 33 is provided with the water adding device 34 that adds the water W according to the swelling speed of the ground soybeans 11, the ground soybeans 11 can be reliably swollen in a short period of time

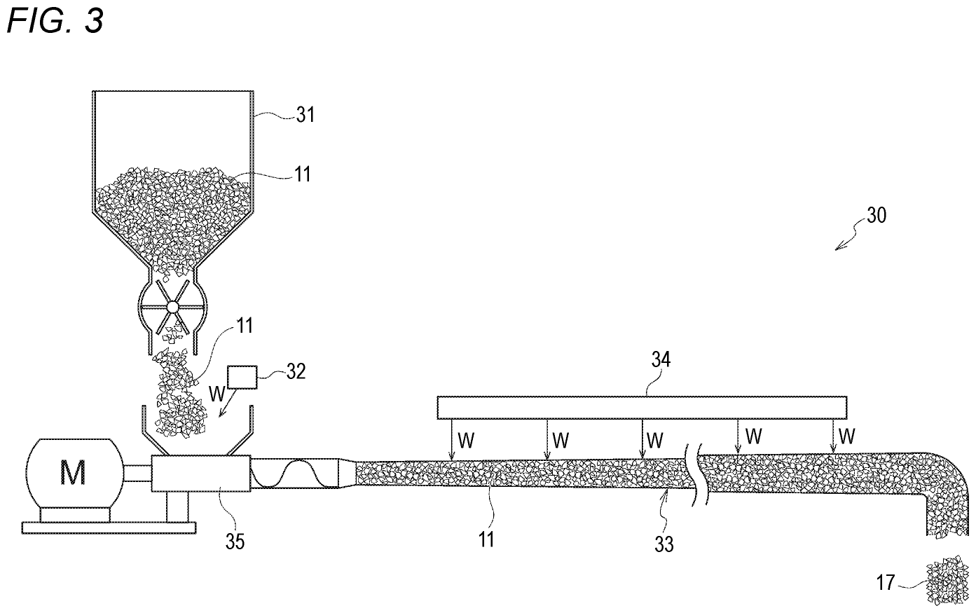

FIG. 3 is a schematic view showing the immersion device 30 of a tofu product production device according to a first modification example of the first embodiment. The cross-sectional area of the pipe 33 of the immersion device 30 of this example increases in accordance with the volumetric swelling caused by the swelling of the ground soybeans 11. The ground soybeans 11 swell and increase in volume as the ground soybeans 11 travel through an inside of the pipe 33, and there is a possibility that the pipe 33 is clogged. In order to prevent this clogging, the pipe 33 has a conical shape, and the cross-sectional area of the pipe 33 is continuously increased in the conveying direction. According to this modification example, the inside of the pipe 33 can be prevented from being clogged with the ground soybeans 11, and the ground soybeans 11 can be stably conveyed in a short period of time and reliably swollen.

In addition, a shape of the pipe 33 is not limited to the conical shape shown in FIG. 3 as long as the cross-sectional area of the shape increases in accordance with the volumetric swelling caused by the swelling of the ground soybeans 11, and any shape may be adopted.

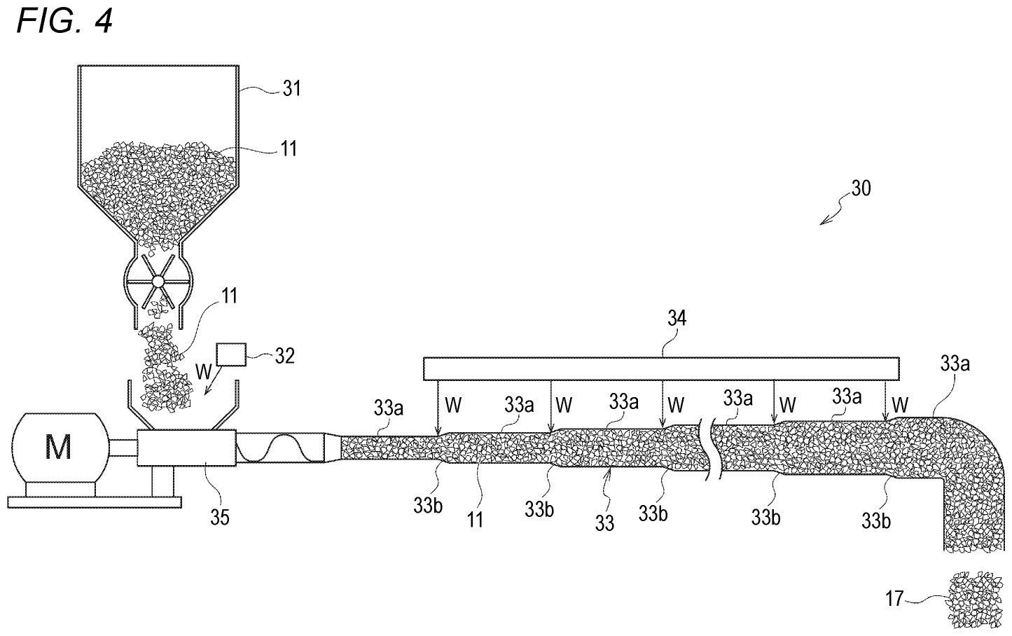

FIG. 4 is a schematic view showing the immersion device 30 of a tofu product production device according to a second modification example of the first embodiment. The cross-sectional area of the pipe 33 of the immersion device 30 of this example increases in accordance with the volumetric expansion caused by the swelling of the ground soybeans 11, as in the first modification example (refer to FIG. 2). The cross-sectional area of the pipe 33 is gradually increased along the conveying direction. That is, the pipe 33 has a plurality of cylinder units 33a with different diameters (cross-sectional areas) arranged side by side in the conveying direction, and a plurality of connection units 33b connecting adjacent cylinder units 33a. Of the adjacent cylinder units 33a and 33a, the cylinder unit 33a downstream in the conveying direction is set to have a larger diameter than the cylinder unit 33a upstream in the conveying direction. The upstream end of the cylinder unit 33a downstream in the conveying direction and the downstream end of the cylinder unit 33a upstream in the conveying direction are connected by the conical connection unit 33b of which diameter increases as going downstream in the conveying direction. According to this modification example, the inside of the pipe 33 can be prevented from being clogged with the ground soybeans 11, and the ground soybeans 11 can be reliably swollen in a short period of time.

In addition, in the example of FIG. 4, the water W supplied from the water adding device 34 is supplied to the upstream end of the connection unit 33b of the pipe 33, that is, the location where the diameter of the pipe 33 begins to increase. Therefore, it is possible to reduce the risk of clogging the pipe 33 due to temporary sudden swelling of the ground soybeans 11.

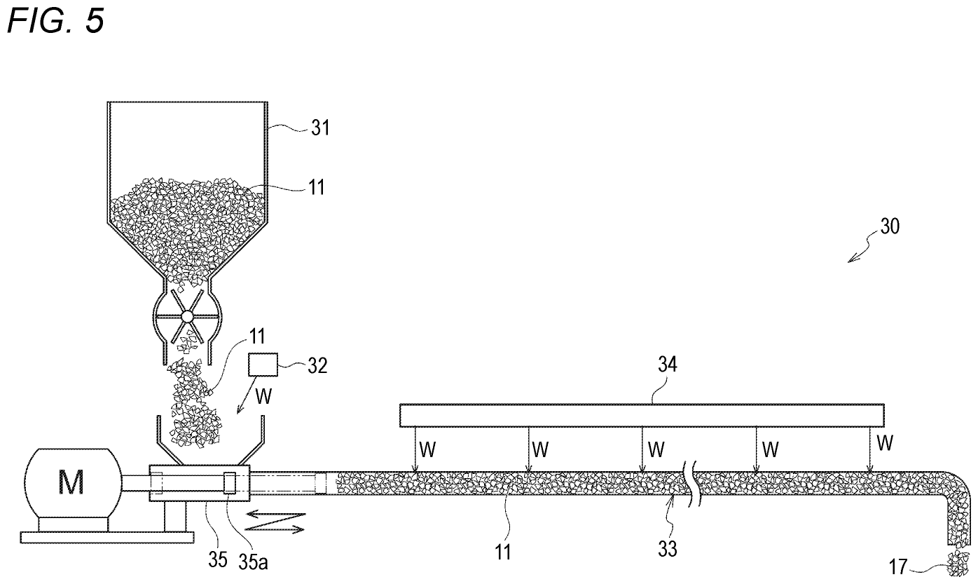

FIG. 5 is a schematic view showing the immersion device 30 of a tofu product production device according to a third modification example of the first embodiment. The immersion device 30 of this modification example differs from that of the first embodiment (refer to FIG. 2) in the configuration of the pump 35. In the immersion device 30 of this modification example, a plunger pump is applied as the pump 35, and the ground soybeans 11 and the water W are supplied toward the pipe 33 by driving a piston 35a with the motor M. By using a plunger pump as the pump 35, the ground soybeans 11 and the water W can be supplied at a higher pressure than a rotary positive displacement single shaft eccentric screw pump, and thus it is possible to prevent the swollen soybeans from clogging the inside of the pipe, and the plunger pump is suitable when the long pipe 33 is used. In addition, even the ground soybeans 11 that are wet with a small amount of the water W (the ground soybeans 11 in a substantially solid state only) can be fed. A plurality of such pipes 33 may be provided in parallel and configured as a batch type continuous immersion device that sequentially feeds the liquid.

In addition, a plunger pump can be applied as the pump 35 not only in the first embodiment shown in FIG. 2 but also in the first and second modification examples shown in FIGS. 3 and 4.

### Second Embodiment

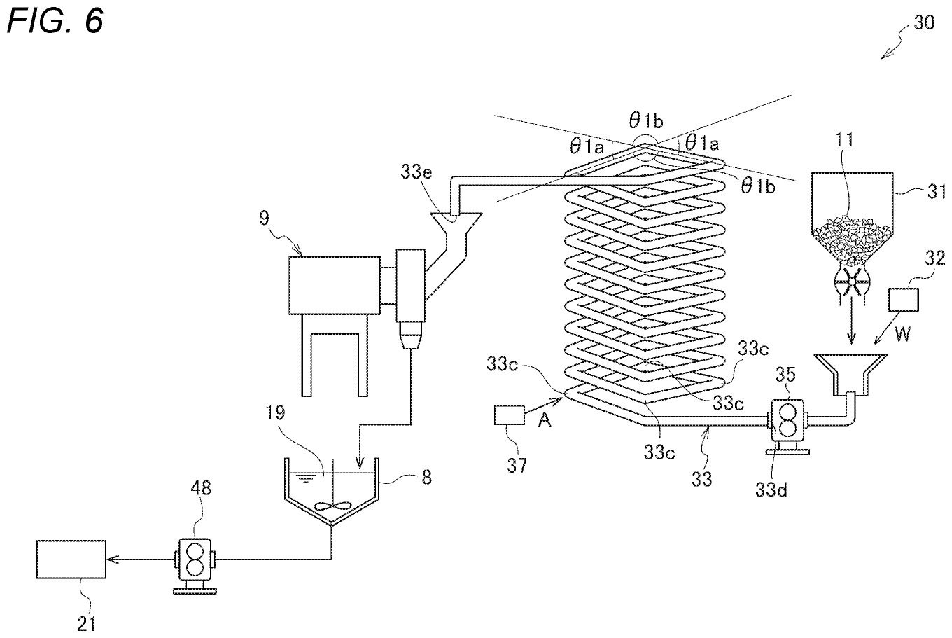

FIG. 6 is a schematic view showing the immersion device 30, the crushing device 9, and the soy milk production device 21 of a tofu product production device according to a second embodiment. The immersion device 30 of this example differs from that of the first embodiment mainly in the configuration of the pipe 33.

The pipe 33 has a spiral shape (coiled shape) in which rhombuses are stacked in an up-down direction in a direction of gravity. The pipe 33 has folded portions 33c at positions corresponding to four corner portions of the rhombus. The folded portion 33c may be formed, for example, by bending the pipe 33, or may be formed by an elbow joint. Angles θ1a and θ1b of the folded portion 33c are preferably small enough to stir the ground soybeans 11 at the folded portion 33c, preferably 180 degrees or less, and more preferably 135 degrees or less. In addition, the angles θ1a and θ1b are preferably 30 to 180 degrees, and more preferably 45 to 90 degrees. Since the pipe 33 is provided with a plurality of the folded portions 33c in this manner, the ground soybeans 11 are conveyed while being stirred inside the pipe 33, and thus, reliable immersion is possible in a short period of time.

Note that the shape of the pipe 33 is not limited to a spiral shape in which rhombuses are stacked as long as the folded portion 33c with the angles θ1a and θ1b of 180 degrees or less is provided, and for example, a shape in which polygons such as triangles and pentagons are stacked may be used.

An air blower 37 that blows air A toward the inside of the pipe 33 is provided at the folded portion 33c of the pipe 33. As the air blower 37, a known one such as an air blow nozzle connected to the pipe 33 via piping can be applied. The ground soybeans 11 adhering to the folded portion 33c can be blown off by the air blower 37. The number of air blowers 37 is not limited, and a plurality of the air blowers 37 may be installed at the plurality of folded portions 33c.

In the pipe 33, an inlet 33d through which the ground soybeans 11 and the water W are supplied from the pump 35 is disposed at the lower part in the direction of gravity compared to an outlet 33e through which the crushing device 9 is supplied with the swollen soybeans 17 and the water W. That is, the pipe 33 has a shape that extends from a lower part to an upper part in the direction of gravity, and conveys the ground soybeans 11 from the lower part to the upper part in the direction of gravity. When the ground soybeans 11 are conveyed from the upper part to the lower part, the water W necessary for swelling of the ground soybeans 11 may flow first, resulting in insufficient swelling of the ground soybeans 11. However, the method of conveying the ground soybeans 11 from the lower part to the upper part can prevent the water W from flowing ahead in the pipe, and the ground soybeans 11 and the water W can be fed simultaneously at a constant speed, and thus swelling can be sufficiently performed.

The ground soybeans 11 immersed in water while being conveyed in the pipe 33 become the swollen soybeans 17 which are at least partially swollen, and the swollen soybeans 17 are supplied to the crushing device 9 together with the water W used for immersion. The swollen soybeans 17 are crushed by the crushing device 9 to be the raw soybean paste 19 and fed to a slurry tank 8. Then, the raw soybean paste 19 is supplied to the soy milk production device 21 by a pump 48 and heated in the soy milk production device 21 to be paste. Subsequent processes are as described above with reference to FIG. 1.

### Third Embodiment

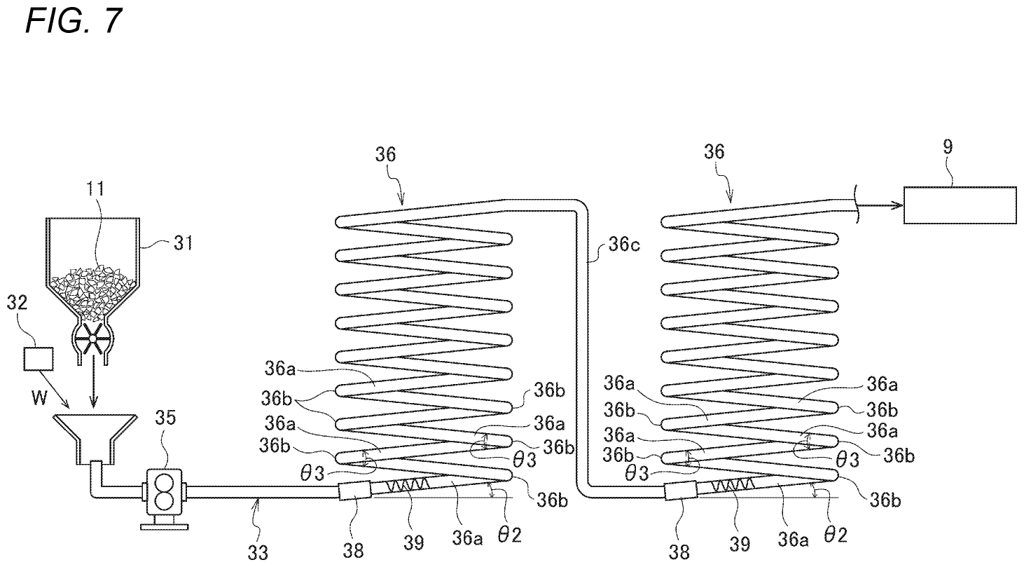

FIG. 7 is a schematic view showing the immersion device 30, the crushing device 9, and the soy milk production device 21 of a tofu product production device according to a third embodiment. The immersion device 30 of this example differs from that of the first embodiment mainly in the configuration of the pipe 33.

The pipe 33 configures a plurality of blocks 36 and 36, and adjacent blocks 36 and 36 are connected by a connecting pipe 36c. Each block 36 is formed to convey the ground soybeans 11 from a lower part to an upper part in a direction of gravity at the angle θ2, and includes a plurality of inclined pipes 36a extending to the upper part in the direction of gravity at the angle θ2 as going downstream in a conveying direction, and a folded portion 36b connecting the inclined pipes 36a to each other. The angle θ2 is preferably 0°<θ2<90°, and more preferably 5°≤θ2≤60°. The folded portion 36b may be formed, for example, by bending the pipe 33, or may be formed by an elbow joint. The angle of the folded portion 36b, that is, the angle θ3 formed by the pair of inclined pipes 36a and 36a adjacent to each other is preferably small enough to stir the ground soybeans 11 at the folded portion 36b, preferably 180 degrees or less, and more preferably 135 degrees or less. In addition, the angle θ3 is preferably 30 to 180 degrees, and more preferably 45 to 90 degrees. By providing a plurality of the folded portions 36b with the angle θ3 on the pipe 33 having an upward slope with the angle θ2, the ground soybeans 11 and water are appropriately stirred in the pipe 33 and conveyed while solid-liquid separation is suppressed, and thus, reliable immersion is possible in a short period of time.

Although not shown in FIG. 7, as in the example of FIG. 6, the air blower 37 that blows the air A toward the inside of the pipe 33 may not be provided at the folded portion 36b of the pipe 33. The ground soybeans 11 adhering to the folded portion 36b can be blown off by the air blower 37. The number of air blowers 37 is not limited, and the plurality of air blowers 37 may be installed at the plurality of folded portions 36b. The stirring effect can be enhanced by incorporating air into the solid-liquid mixture.

A heating device 38 that heats the water in the pipe 33 is provided in the inclined pipe 36a on the most upstream side in the conveying direction (the lowest part in the direction of gravity) among the plurality of inclined pipes 36a. Examples of the heating device 38 include a steam supply device, a jacket disposed around a pipe, a double pipe, and the like. By providing the heating device 38 in this manner, even when the water W added from the water supply device 32 to the pump 35 is cold water, the water can be heated by the heating device 38 to the water temperature necessary for immersion in a short period of time. In this case, the temperature of the water W (cold water) added from the water supply device 32 to the pump 35 together with the ground soybeans 11 is, for example, 0 to 20° C., and is heated to, for example, 30 to 95° C. by the heating device 38. In the final process of the immersion device 30, for example, cold water of 0 to 20° C. may be added to suppress excessive immersion of the ground soybeans 11. A device for supplying such cold water includes, for example, a chiller water supply device.

Moreover, a static mixer 39 may be provided inside the inclined pipe 36a on the most upstream side in the conveying direction (the lowest part in the direction of gravity) among the plurality of inclined pipes 36a. Therefore, the ground soybeans 11 and water passing through the static mixer 39 are mixed and stirred, and can be immersed efficiently. In addition, a dynamic mixer driven by a motor or air may be used instead of the static mixer 39.

In addition, the installation position, the number, and the like of the heating device 38 and the static mixer 39 are not particularly limited. Moreover, the heating device 38 and the static mixer 39 can also be applied in the second embodiment shown in FIG. 6. Also, in the example of FIG. 7, the pipe 33 has two blocks 36 and 36, but the number of blocks 36 is not limited, and may be one or three or more.

The ground soybeans 11 immersed in the water W while being conveyed in the pipe 33 become the swollen soybeans 17 which are at least partially swollen, and the swollen soybeans 17 are supplied to the crushing device 9 together with the water W used for immersion. Subsequent processes are as described above with reference to FIG. 1.

### Fourth Embodiment

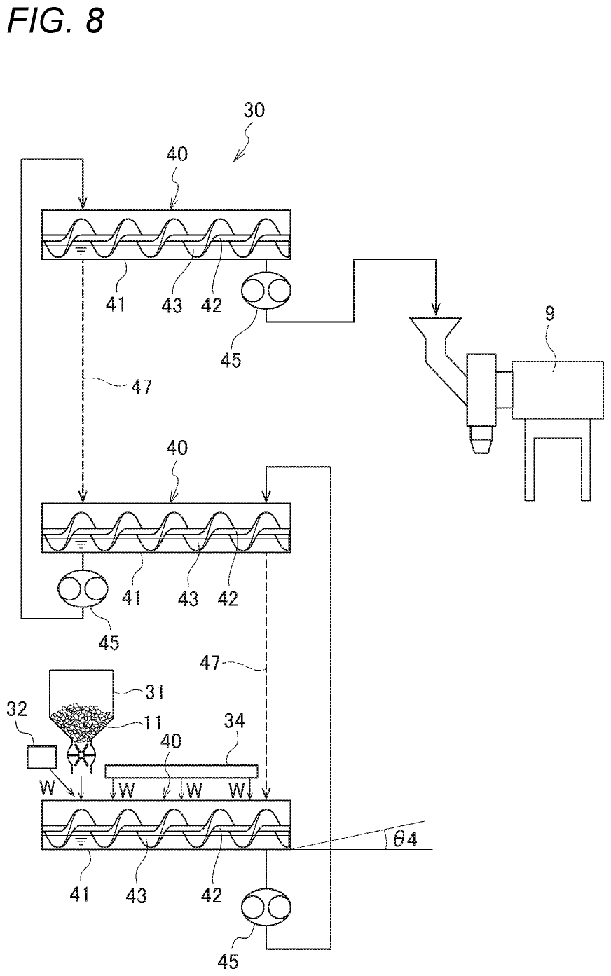

FIG. 8 is a schematic view showing the immersion device 30 of a tofu product production device according to a fourth embodiment. The immersion device 30 of the present embodiment is a continuous screw conveyor type immersion device including the hopper 31 into which the ground soybeans 11 obtained by the grinding device 5 are added; a trough 41 configuring a conveyance channel for conveying the ground soybeans 11 while the ground soybeans 11 are immersed in the water W; and a screw 43 that is rotatably provided inside the trough 41.

The trough 41 is a long tank extending in the direction orthogonal to a direction of gravity (horizontal to the ground). The screw 43 is suspended in a longitudinal direction inside the trough 41 via a rotating shaft 42 and is rotatable by a motor (not shown).

The immersion device 30 of the present embodiment includes a plurality of (three in the shown example) trough/screw devices 40 each having the trough 41 and the screw 43, and the plurality of trough/screw devices 40 are provided in multiple stages in the up-down direction in the direction of gravity. The conveyance of the ground soybeans 11 and the water W between the trough/screw devices 40 is performed by a pump 45.

The trough/screw device 40 upstream of a conveyance process is disposed at the lower part in the direction of gravity compared to the trough/screw device 40 downstream of the conveyance process. As a result, the ground soybeans 11 and the water W are conveyed by the pump 45 from the trough/screw device 40 at a lower stage (lower part in the direction of gravity) to the trough/screw device 40 at an upper stage (upper part in the direction of gravity).

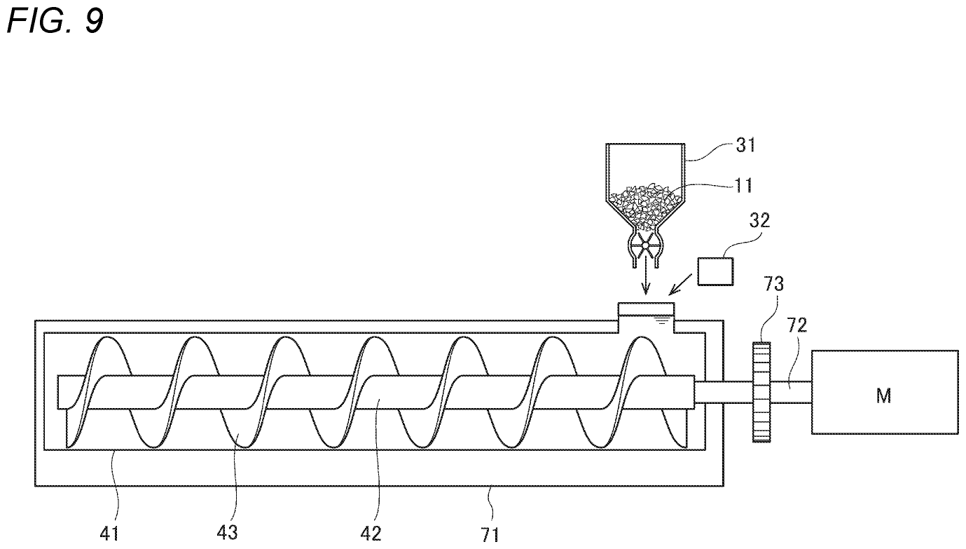

The trough 41 may be of a closed type such as a sealed pipe or an open type with an open top. FIG. 9 is a view showing the trough 41 according to a modification example. As shown in FIG. 9, regardless of whether the trough 41 is of closed type or open type, a jacket 71 is disposed around the trough 41, and accordingly, conveyance while retaining heat, or heating or cooling in the middle of immersion is possible. With the jacket 71, heat retention or heating is possible. Therefore, after the warm water of which temperature is adjusted in advance and the ground soybeans 11 heated to a predetermined temperature are added into the trough 41, the jacket 71 prevents the temperature from dropping. In addition, FIG. 9 shows the motor M for driving the screw 43, a shaft 72 connecting the motor M and the rotating shaft 42, and a gear 73 provided on the outer circumference of the shaft 72.

The number of screws 43 provided inside one trough 41 may be one or plural (one in the examples of FIGS. 8 and 9).

In the trough 41, the added warm water and soybeans are allowed to travel in a first-in first-out manner as much as possible while avoiding overflow of bubbles and floating of some soybeans and skins, and thus the amount of warm water may be as much as necessary for swelling of the ground soybeans 11. In this case, the ground soybeans 11 are conveyed in a sludge state in the trough 41, and when only one screw 43 is used, there is a possibility that proper conveyance is not possible due to corotation. In such a case, it is preferable that the number of screws 43 in the trough 41 is plural.

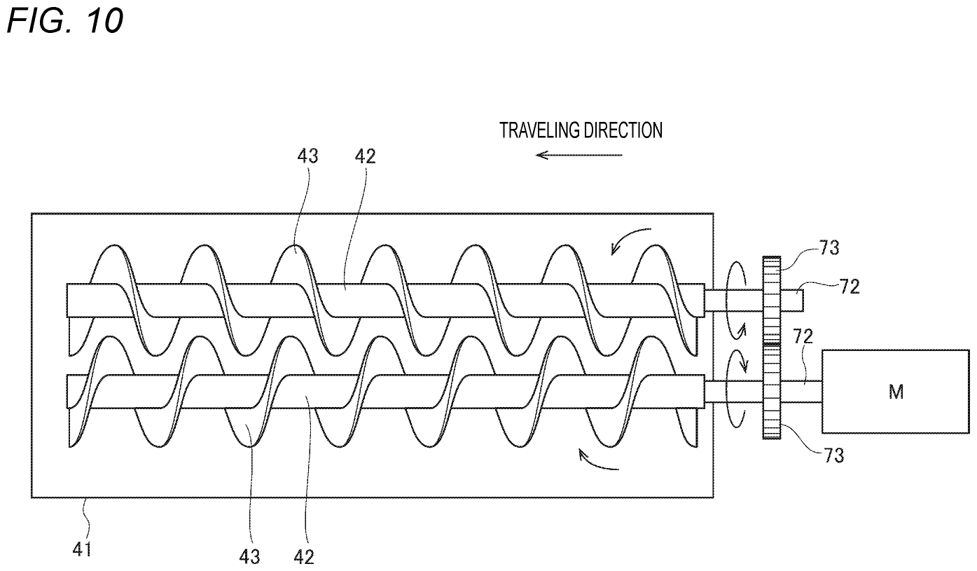

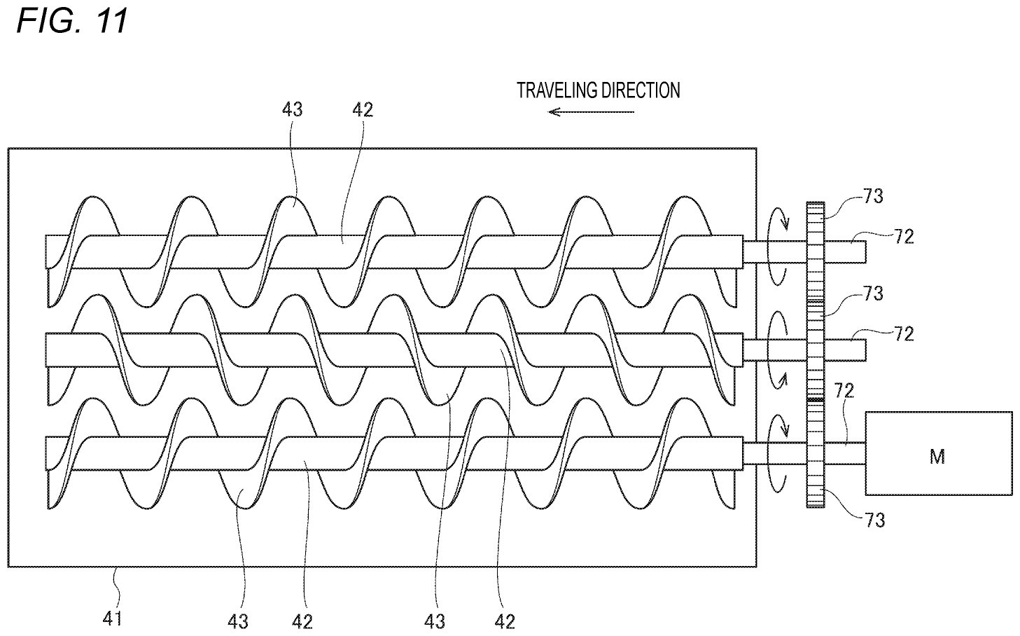

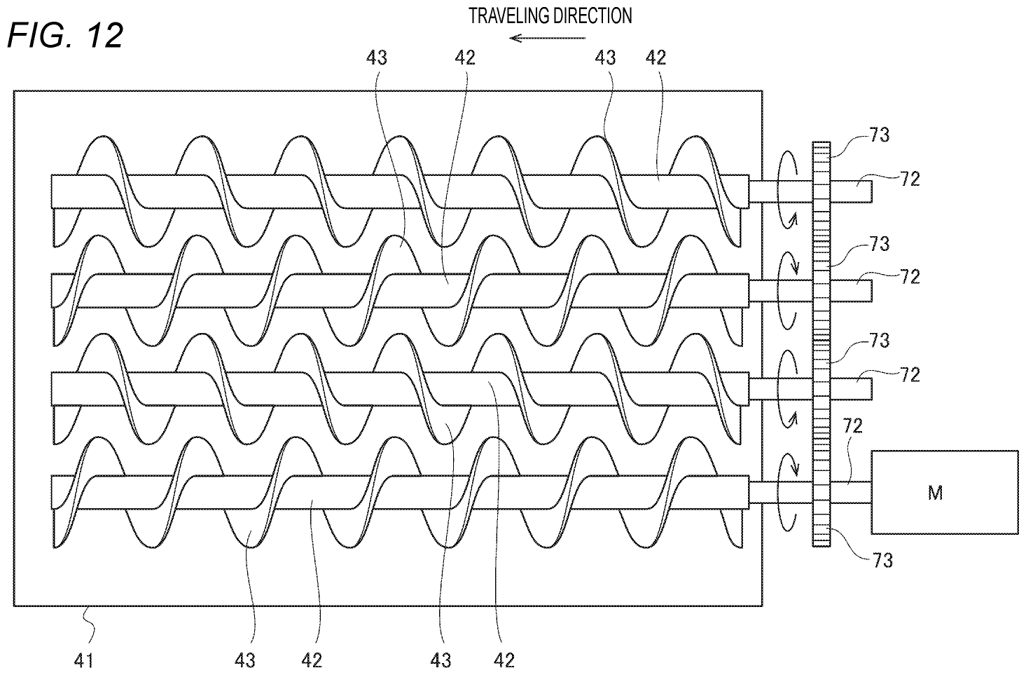

FIGS. 10 to 12 are views showing the trough 41 according to a modification example. As shown in FIGS. 10 to 12, a plurality of the screws 43 (two in FIG. 10, three in FIG. 11, and four in FIG. 12) are provided inside the trough 41, and accordingly, it is possible to stably convey the ground soybeans 11 without backflow. In addition, the amount of ground soybeans 11 that can be conveyed at one time increases, which also leads to the improvement in production capacity. The screws 43 adjacent to each other may rotate in the same direction or in opposite directions, but preferably rotate in opposite directions. As shown in FIGS. 10 to 12, when the gears 73 of the shafts 72 of the adjacent screws 43 are meshed with each other, the rotation directions of the screws 43 adjacent to each other can be reversed. In addition, the directions and the rotation directions of the spiral blades of the screws 43 adjacent to each other are also preferably reversed between the screw shafts adjacent to each other. Moreover, the spiral blade of the screw 43 is preferably one single spiral blade as shown in FIGS. 8 to 12, 14, 15, and 17. Further, the screw 43 may be provided with the plurality of spiral blades such as a double spiral blade provided with double spiral blades in the same direction on one shaft in order to increase the conveyance capacity.

In the example of FIG. 8, first, the ground soybeans 11 are added into the hopper 31 from the grinding device 5. Next, the ground soybeans 11 from the hopper 31 and the water W from the water supply device 32 are supplied to the trough/screw device 40 at a lowermost stage. Here, the water W is warm water, preferably 30 to 95° C., more preferably 40 to 80° C., and even more preferably 50 to 70° C.

Moreover, in each trough/screw device 40, it is preferable that a water level in the trough 41 is lower than the rotating shaft 42. However, when the water level is extremely low, the ground soybeans 11 may adhere to the screw 43, and thus, it is more preferable that the water level is as close to the bottom of the shaft as possible. In addition, in order to reduce the clearance between the lower semicircular portion of the trough cross section and the screw gap to zero, it is preferable to provide at least a flexible member (seal member) made of rubber or resin on the outer circumference of the screw to be in close contact with the inner surface of the trough, and to prevent water leakage (only water does not move back and forth).

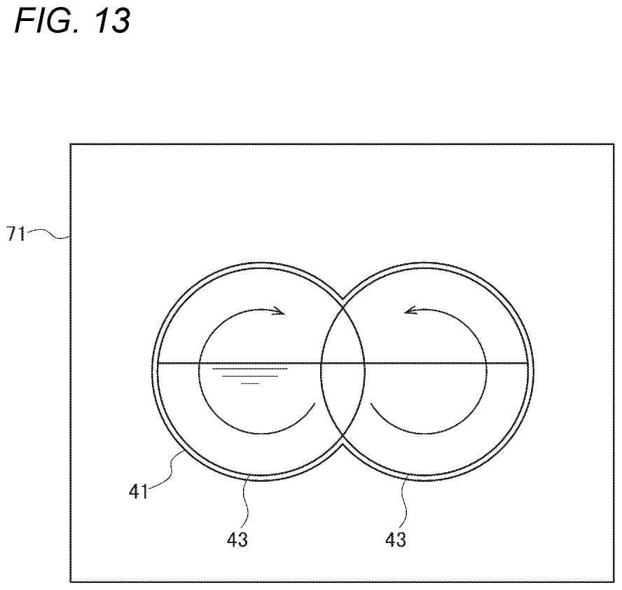

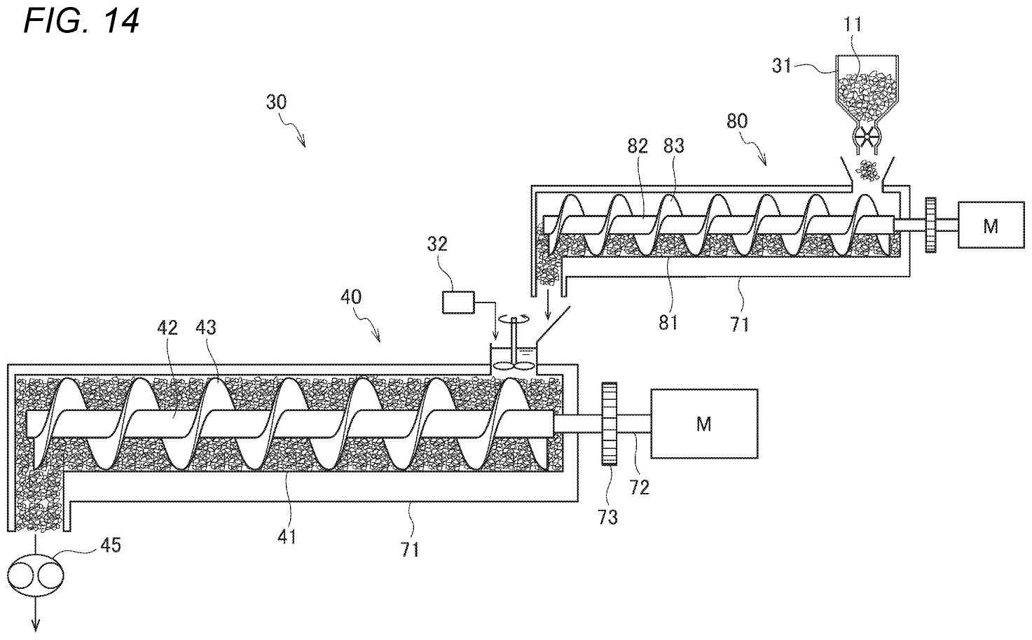

However, when two or more screws 43 are provided, the water level in the trough 41 may be the amount of water necessary for swelling of the soybeans, and it is possible to convey the soybeans in a sludge state. By using two or more screws, it is possible to avoid the current situation where bubbles overflow and some soybeans and skins float, and the added warm water and soybeans can be conveyed in a first-in first-out manner as much as possible. FIG. 13 is a view of the trough 41 according to a modification example, viewed from the axial direction. FIG. 14 is a schematic view showing the immersion device 30 according to a modification example As shown in FIGS. 13 and 14, when the trough 41 is a closed type, it is better to have a stirring blade above the outer circumference of the screw 43 at the input port when the trough 41 is full of liquid, and the soybeans and skins adhering to the surface can be quickly blended with warm water In the immersion device 30 shown in FIG. 14, a soybean heating conveyance device 80 to which the ground soybeans 11 obtained by the grinding device 5 are supplied through the hopper 31 and that supplies the ground soybeans 11 to the downstream trough/screw device 40, is provided. The soybean heating conveyance device 80 has the same configuration as the trough/screw device 40, and includes a trough 81 configuring a conveyance channel for conveying the ground soybeans 11; a screw 83 that is rotatably provided inside the trough 81; a rotating shaft 82 that suspends the screw 83 in the longitudinal direction inside the trough 81; and the motor M that drives the rotating shaft 82. The circumference of the trough 81 is covered with the jacket 71, and the ground soybeans 11 heated by the jacket 71 are supplied to the downstream trough/screw device 40.

In addition, in the example of FIG. 8, the ground soybeans 11 are continuously immersed in the trough/screw device 40 at the lowermost stage by being rotated by the screw 43 and traveling through the inside of the trough 41 from the left to the right in FIG. 8. The traveling speed of the ground soybeans 11 in the trough 41 can be freely adjusted by the rotation speed of the screw 43, and is adjusted in consideration of the time required for immersing the ground soybeans 11 and the like.

The ground soybeans 11 traveling to the downstream end of the trough/screw device 40 at the lowermost stage are fed to the trough/screw device 40 at a middle stage by the pump 45 together with the water W. The ground soybeans 11 are continuously immersed in the trough/screw device 40 at the middle stage by being rotated by the screw 43 and traveling through the inside of the trough 41 from the right to the left in FIG. 8.

In addition, in the example of FIG. 8, the trough 41 configuring the conveyance channel extends horizontally with respect to the ground, and the angle θ4 between the ground and the extending direction of the trough 41 is 0 degrees. However, the trough 41 may be formed to convey the ground soybeans 11 at the angle θ4 from the lower part to the upper part in the direction of gravity. That is, the trough 41 may have an upward slope with the angle θ4 exceeding 0 degrees. The angle θ4 is preferably 0<θ4≤90°, and more preferably 5°≤θ4≤30°.

The ground soybeans 11 traveling to the downstream end of the trough/screw device 40 at the middle stage are fed to the trough/screw device 40 at an uppermost stage by the pump 45 together with the water W. The ground soybeans 11 are continuously immersed in the trough/screw device 40 at the uppermost stage by being rotated by the screw 43 and traveling through the inside of the trough 41 from the left to the right in FIG. 8.

The ground soybeans 11 traveling to the downstream end of the trough/screw device 40 at the uppermost stage become the swollen soybeans 17 which are at least partially swollen, and the swollen soybeans 17 are supplied to the crushing device 9 by the pump 45 together with the water W used for immersion. Subsequent processes are as described above with reference to FIG. 1.

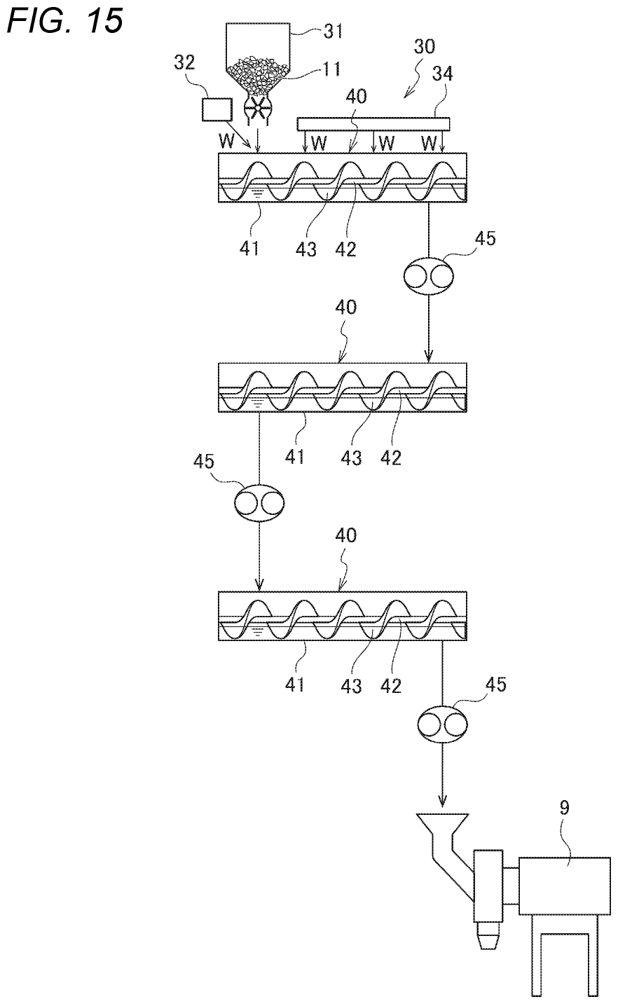

FIG. 15 is a schematic view showing the immersion device 30 of a tofu product production device according to a reference example of the fourth embodiment. In this example, the ground soybeans 11 and the water W are conveyed from the trough/screw device 40 at the upper stage to the trough/screw device 40 at the lower stage In this case, in the pump 45 used when the ground soybeans 11 and the water W are conveyed from the trough/screw device 40 at the upper stage to the trough/screw device 40 at the lower stage, the water W leaks, and only the water W first flows to the trough/screw device 40 at the lower stage. Therefore, when the ground soybeans 11 are conveyed to the trough/screw device 40 at the lower stage, the water W necessary for swelling may be insufficient, and the swelling of the ground soybeans 11 may be insufficient. Since it is difficult to provide hermetic seals in the trough/screw device 40, there are gaps between the screw 43 and the trough 41, and gaps between the rotor and the casing of the pump 45. Therefore, a small amount of water W tends to escape from these gaps, a phenomenon occurs in which only the liquid from the solid-liquid mixture flows ahead in the flow from the upper part to the lower part in the direction of gravity, and thus conveyance becomes difficult while keeping the solid-liquid ratio constant.

On the other hand, according to the present embodiment shown in FIG. 8, since the ground soybeans 11 and the water W are conveyed from the trough/screw device 40 at the lower stage to the trough/screw device 40 at the upper stage, only water does not flow ahead upward through the gap, and thus the solid-liquid mixture can be stably conveyed while maintaining the solid-liquid ratio. In addition, even when too much water W is fed from the trough/screw device 40 at the lower stage to the trough/screw device 40 at the upper stage, the excess water W can be returned by a return channel 47. The return channel 47 is configured with, for example, a pump and a valve. The return channel 47 collects the liquid (water; aqueous solution of soybean components) by solid-liquid separation performed by a filter unit provided at a predetermined location on the bottom surface of the trough 41 and returns the liquid to the previous process. The collected liquid may be used for adding water in the crushing device. In addition, in the immersion device 30, the minimum amount of water necessary for conveyance with a constant solid-liquid ratio may be sufficient, extra water may be used for adding water to new ground soybeans 11, and can also be used for adjusting soy milk concentration in the crushing process or the heating process subsequent to the immersion process, and the soybean component solution can be effectively used without being discarded to ensure yield.

However, when there is no such inconvenience, the immersion device 30 according to the reference example of FIG. 15 may be used.

Also, in both FIGS. 8 and 15, the water adding device 34 shown in FIG. 2 may be provided, a predetermined amount of water W necessary for immersing the ground soybeans 11 from the water supply device 32 may not be added all at once, and the water W added from the water supply device 32 to the pump 35 may be added gradually and limitedly at various locations in the middle of the conveyance channel by the water adding device 34 as a part of the predetermined amount.

Although not shown in FIGS. 8 and 15, the outside of the trough/screw device 40 is covered with the jacket 71, a heat insulating material, or the like as shown in FIG. 9, and accordingly, it is also possible to perform conveyance while keeping the temperature of the water W constant.

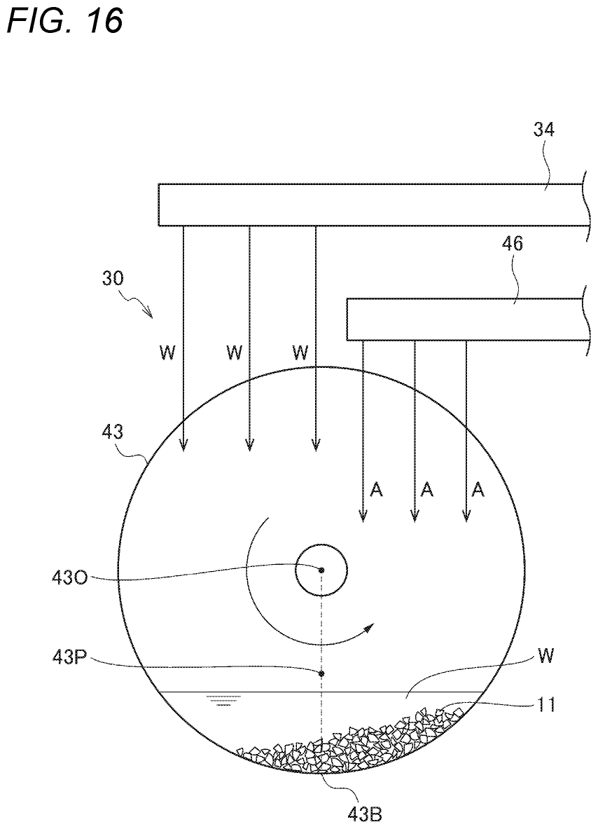

FIG. 16 is a view showing the single-staged screw 43 of the immersion device 30 of a tofu product production device according to a modification example of the fourth embodiment. In this modification, an air blower 46 for wiping off the ground soybeans 11 adhering to the screw 43 with the air A is provided above the screw 43 in the direction of gravity. As the air blower 46, a known one such as an air blow nozzle can be applied.

The air blower 46 can also be applied to the multi-stage screw conveyor type immersion device 30 shown in FIG. 8, but is particularly suitable for the single-stage screw 43 in which the diameter of the screw 43 is large compared to the water level and to which the ground soybeans 11 tend to adhere. For example, the screw 43 provided with the air blower 46 preferably has the water level lower than a center 43O of the screw 43, and more preferably has the water level lower than a middle portion 43P between the center 43O and a bottom portion 43B of the screw 43 in the direction of gravity. The screw 43 preferably has a diameter of, for example, 50 cm or more, and more preferably 70 cm or more.

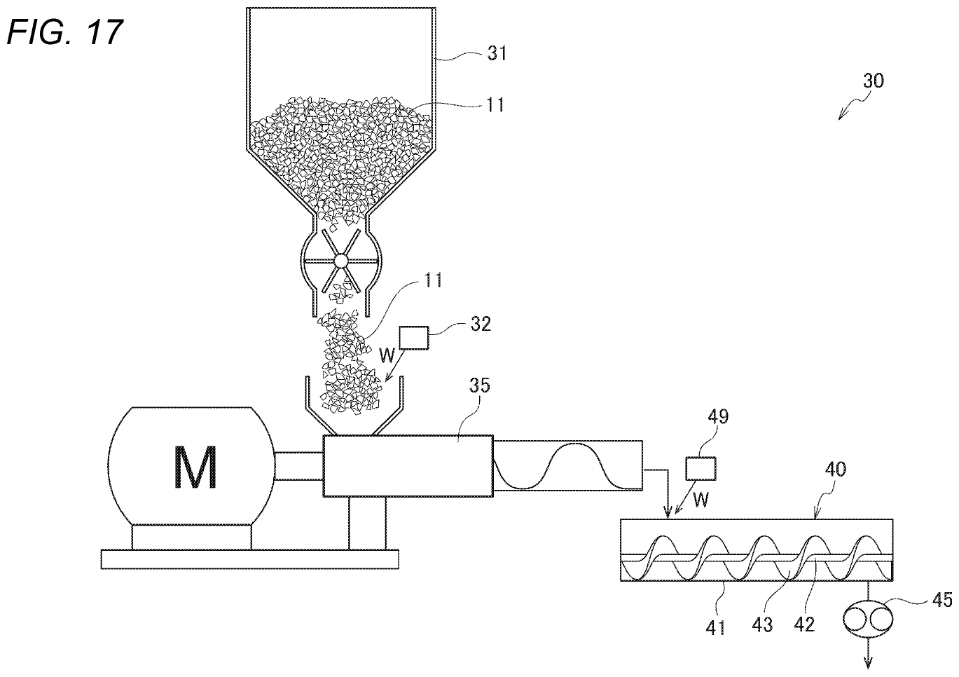

FIG. 17 is a schematic view showing the immersion device 30 of a tofu product production device according to a modification example of the fourth embodiment. The immersion device 30 is provided with the pump 35 to which the ground soybeans 11 obtained by the grinding device 5 are supplied through the hopper 31 and to which the water W is supplied by the water supply device 32. The pump 35 is a rotary positive displacement single shaft eccentric screw pump, and for example, Mohno Pump (registered trademark) can be applied.

The pump 35 supplies the trough/screw device 40 of the immersion device 30 with the ground soybeans 11 and the water W while mixing the ground soybeans 11 and the water W. Therefore, the ground soybeans 11 and the water W are supplied in a first-in first-out manner to the trough/screw device 40, and at the time of supply to the trough/screw device 40, the ground soybeans 11 and the water W are mixed into a sludge. Therefore, in the trough/screw device 40, separation of the ground soybeans 11 and the water W can be prevented, and immersion can be performed in a short period of time.

In this example, the amount of water W supplied to the pump 35 by the water supply device 32 is the minimum amount necessary for mixing the ground soybeans 11 and the water W in the pump 35 to form a sludge (slurry, solid-liquid mixture). Therefore, the ground soybeans 11 and the water W are added from the pump 35 to the trough/screw device 40, and the water W necessary for immersion is added from another water supply device 49. Moreover, the water adding device 34 of FIG. 2 may be used for water supply.

The ratio of the amount of water W added from the water supply device 32 to the pump 35 and the amount of water W added from another water supply device 49 to the trough/screw device 40 is, for example, 5:5, preferably 4:6, and more preferably 3:7. In addition, the temperature of the water W added from the water supply device 32 to the pump 35 is, for example, 20 to 95° C., preferably 30 to 80° C., and more preferably 40 to 70° C. The temperature of the water W added from another water supply device 49 to the trough/screw device 40 is 20 to 95° C., preferably 30 to 80° C., and more preferably 40 to 70° C.

### Fifth Embodiment

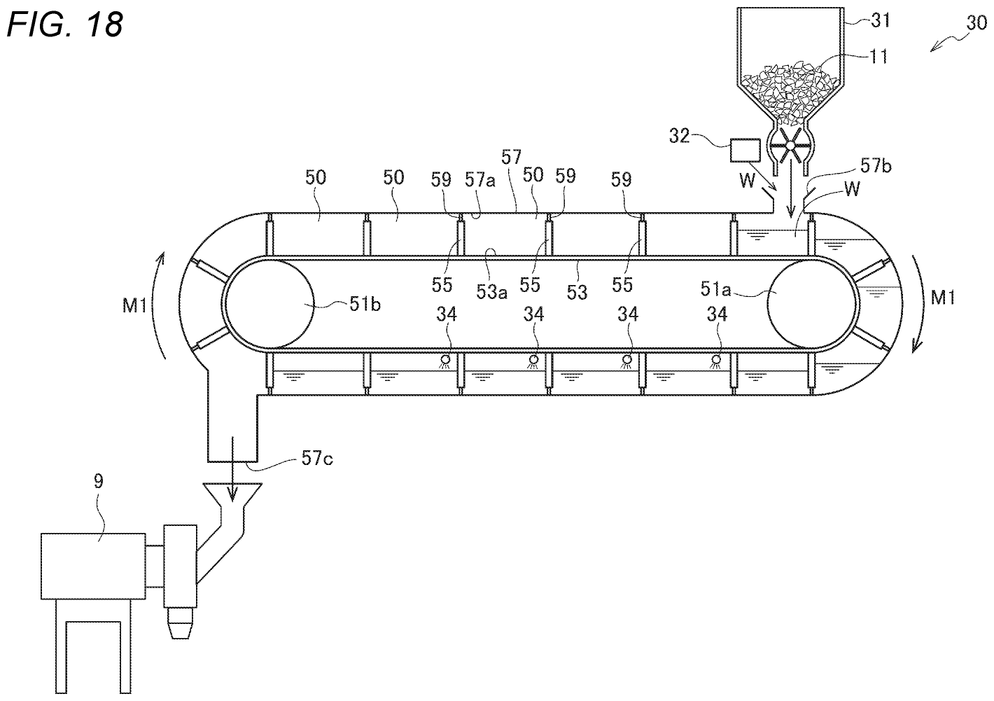

FIG. 18 is a schematic view showing the immersion device 30 of a tofu product production device according to a fifth embodiment. The immersion device 30 is a batch type continuous immersion device including a first roller 51a and a second roller 51b that are disposed to be spaced apart in the horizontal direction (the direction orthogonal to a direction of gravity) and rotatable by a drive source such as a motor; an endless belt member 53 that is supported by the first roller 51a and the second roller 51b; a plurality of wall members 55 that are erected at intervals on an outer circumferential surface 53a of the belt member 53; and a housing 57 that encloses the belt member 53 and the plurality of wall members 55 to surround the belt member 53 and the plurality of wall members 55.

A seal member 59 such as a rubber spatula is fixed to the tip end of the wall member 55, and the seal member 59 is in sliding contact with the inner circumferential surface of the housing 57. Therefore, a plurality of immersion tanks 50 are formed by the pair of adjacent wall members 55 and 55, the pair of adjacent seal members 59 and 59, the outer circumferential surface 53a of the belt member 53, an inner circumferential surface 57a of the housing 57, and both side surfaces (not shown) in the depth direction of the paper surface.

By rotating the first roller 51a and the second roller 51b, the belt member 53, the plurality of wall members 55, and the plurality of seal members 59 are driven in a direction of the arrow M1 (clockwise) in the drawing, and along with this, the plurality of immersion tanks 50 also move in the direction of the arrow M1.

The housing 57 has an input port 57b for adding the ground soybeans 11 from the hopper 31 and the water W from the water supply device 32, directly below the hopper 31 (near the upper portion of the first roller 51a). Therefore, when the immersion tank 50 moves to the position communicating with the input port 57b, the ground soybeans 11 and the water W are supplied to the immersion tank 50, and the immersion of the ground soybeans 11 is started.

The ground soybeans 11 supplied to the immersion tank 50 are conveyed in the direction of the arrow M1 while being swollen by being immersed in the water W. The housing 57 has a discharge port 57c for discharging the swollen soybeans 17 and the water W used for immersion from the immersion tank 50 to the crushing device 9, near the lower portion of the second roller 51b.

Therefore, the temperature of the water W supplied by the water supply device 32, the conveying speed of the immersion tank 50, and the like are set such that the ground soybeans 11 added through the input port 57b swell and become the swollen soybeans 17 before being discharged through the discharge port 57c. The temperature of the water W supplied by the water supply device 32 is, for example, 20 to 90° C., preferably 30 to 80° C., and more preferably 40 to 70° C. The immersion time of the ground soybeans 11 is, for example, 1 minute to 3 hours, preferably 1 minute to 1 hour, and more preferably 1 minute to 30 minutes.

The immersion device 30 may be provided with the water adding device 34 for adding the water W according to the swelling speed of the ground soybeans 11. The water adding device 34 is, for example, a shower head, and supplies the water W to the immersion tank 50 such that the swelling speed of the ground soybeans 11 is maintained within a desired range. The temperature of the water W supplied by the water adding device 34 is, for example, 20 to 95° C., preferably 30 to 80° C., and more preferably 40 to 70° C. By setting the temperature of the water W within this temperature range, the effect of shortening the immersion time is exhibited by adding the high-temperature water W, and the effect of suppressing the swelling speed is exhibited by adding the low-temperature water W.

Note that the immersion device 30 of the present embodiment is relatively compact and performs immersion in a short period of time. Therefore, it is suitable for the ground soybeans 11 that can be immersed in a short period of time rather than whole soybeans that require a relatively long period of time for immersion.

In this manner, the ground soybeans 11 immersed in the water W while being conveyed in the immersion tank 50 become the swollen soybeans 17 which are at least partially swollen, and the swollen soybeans 17 are supplied through the discharge port 57c to the crushing device 9 together with the water W used for immersion. Subsequent processes are as described above with reference to FIG. 1.

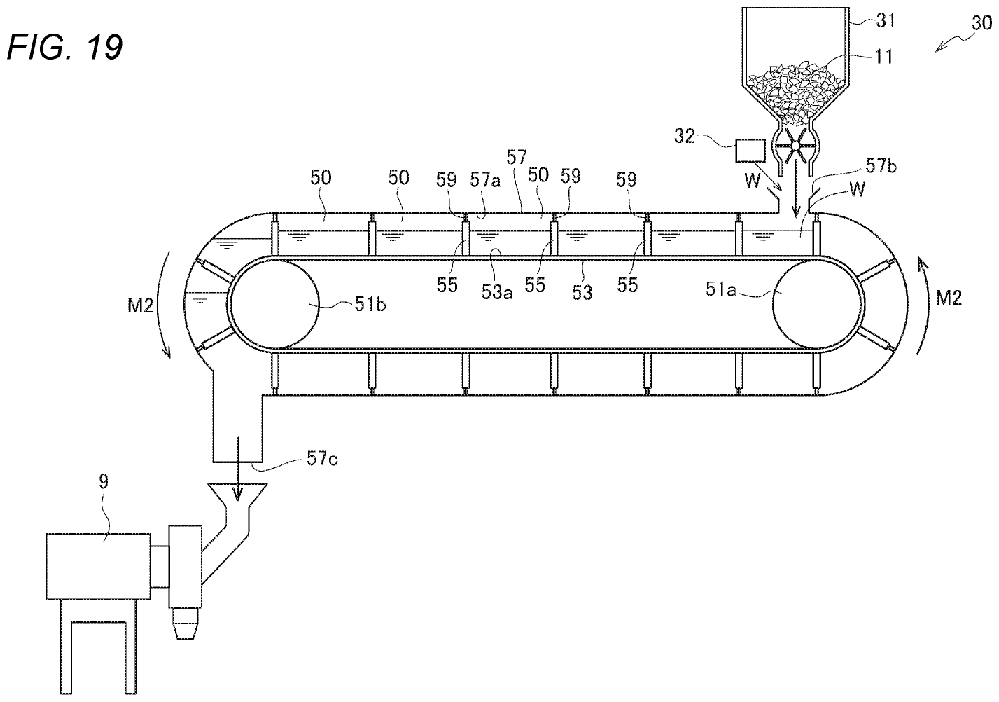

FIG. 19 is a schematic view showing the immersion device 30 of a tofu product production device according to a modification example of the fifth embodiment. In this modification example, by rotating the first roller 51a and the second roller 51b, the belt member 53, the plurality of wall members 55, and the plurality of seal members 59 are driven in a direction of the arrow M2 (counterclockwise) in the drawing, and along with this, the plurality of immersion tanks 50 also move in the direction of the arrow M2. Other configurations and effects are the same as those of the fifth embodiment shown in FIG. 18, and thus the description thereof will be omitted.

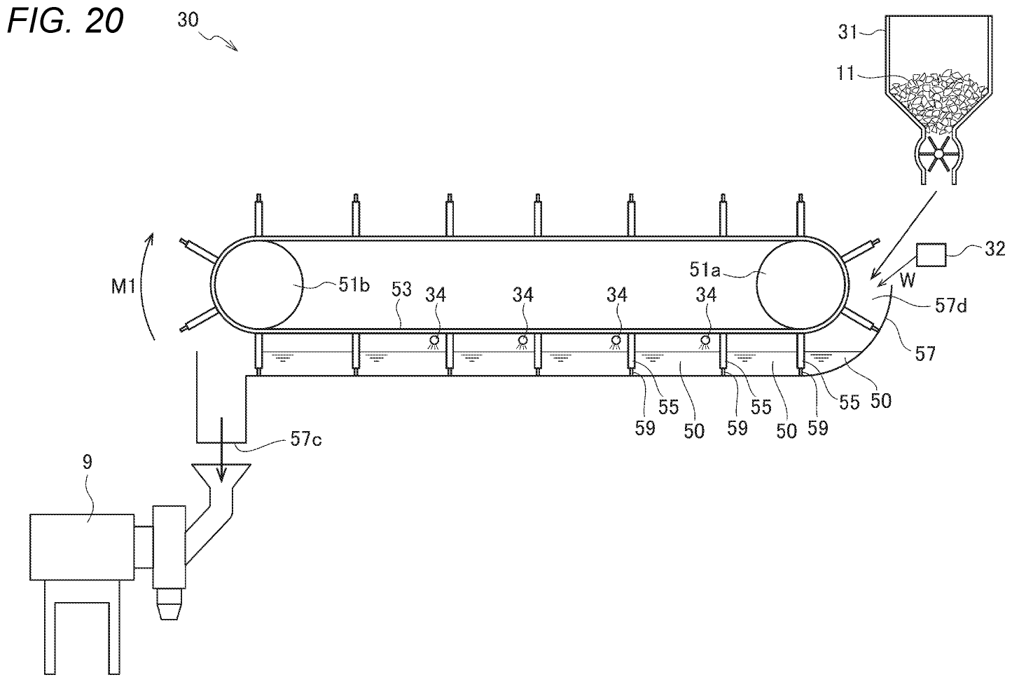

FIG. 20 is a schematic view showing the immersion device 30 of a tofu product production device according to a modification example of the fifth embodiment. The housing 57 of this modification example has the upper portion removed in the direction of gravity, and has a bottomed container shape having an opening 57d on the side of the first roller 51a. Therefore, the opening 57d serves as an input port into which the ground soybeans 11 and the water W are added. In addition, the ground soybeans 11 supplied through the opening 57d to the immersion tank 50 are conveyed in the direction of the arrow M1 while being swollen by being immersed in the water W. In addition, the ground soybeans 11 immersed in the water W while being conveyed in the immersion tank 50 become the swollen soybeans 17 which are at least partially swollen, and the swollen soybeans 17 are supplied through the discharge port 57c to the crushing device 9 together with the water W used for immersion. Subsequent processes are as described above with reference to FIG. 1.

### Sixth Embodiment

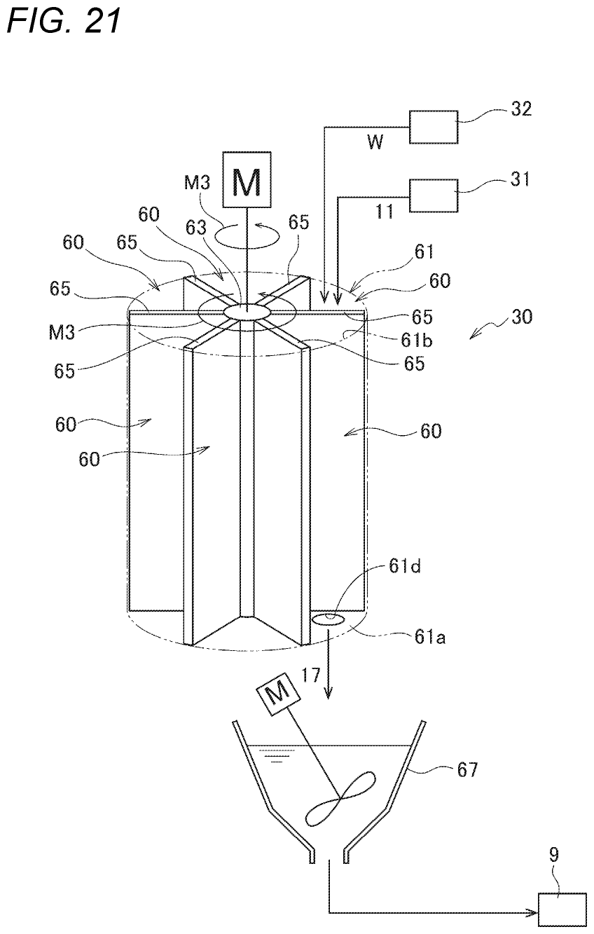

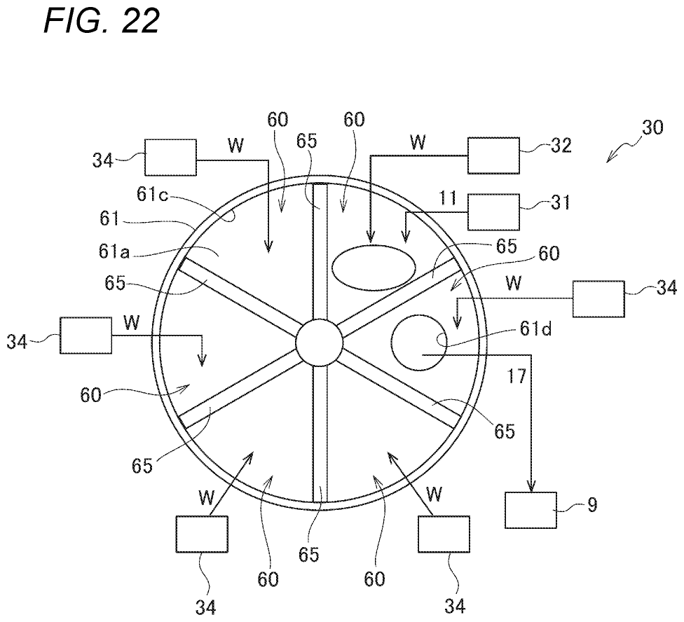

FIG. 21 is a perspective view showing the immersion device 30 of a tofu product production device according to a sixth embodiment. FIG. 22 is a view of the immersion device 30 of the tofu product production device according to the sixth embodiment, viewed from above in a direction of gravity.

The immersion device 30 is an example of a batch type continuous immersion device including a cylindrical housing 61 that extends in an up-down direction in the direction of gravity; a shaft member 63 that extends in the up-down direction in the direction of gravity at the center of the housing 61; the motor M that rotates the shaft member 63; and a plurality of wall members 65 that extend outward in the radial direction from an outer circumferential surface of the shaft member 63.

The housing 61 has a bottomed container shape, has a bottom surface 61a at a lower part in the direction of gravity, and has an opening 61b at an upper part in the direction of gravity. The lengths in the up-down direction of the shaft member 63 and the wall member 65 are substantially the same as the housing 61. Further, in the shown example, six wall members 65 are disposed at equal intervals in the circumferential direction, and the tip end portions thereof are in sliding contact with an inner circumferential surface 61c of the housing 61. Therefore, a plurality of (six in the shown example) immersion tanks 60 are formed by the pair of adjacent wall members 65 and 65, the outer circumferential surface of the shaft member 63, and the inner circumferential surface 61c and the bottom surface 61a of the housing 61. In addition, it is preferable to provide a seal member at the tip end of the wall member which is in contact with the housing to reduce the clearance between the wall member and the housing to zero and to prevent water leakage.

By rotating the shaft member 63 and the wall member 65 in a direction of the arrow M3 by the motor M, the plurality of immersion tanks 60 are similarly moved in the direction of the arrow M3.

The bottom surface 61a of the housing 61 has a discharge port 61d for discharging the swollen soybeans 17 and the water W used for immersion from the immersion tank 60 to the crushing device 9. The hopper 31 for supplying the ground soybeans 11 and the water supply device 32 for supplying the water W are disposed at positions shifted from the discharge port 61d in the rotation direction of the motor M (in the direction of the arrow M3). Therefore, when the immersion tank 60 moves to the position where the hopper 31 and the water supply device 32 are provided, the ground soybeans 11 from the hopper 31 and the water W from the water supply device 32 are supplied to the immersion tank 60, and the immersion of the ground soybeans 11 is started.

The ground soybeans 11 supplied to the immersion tank 60 are conveyed in the direction of the arrow M3 while being swollen by being immersed in the water W. As described above, since the housing 61 has the discharge port 61d, the temperature of the water W supplied by the water supply device 32, the conveying speed of the immersion tank 60, and the like are set such that the ground soybeans 11 swell and become the swollen soybeans 17 before being discharged through the discharge port 61d. The temperature of the water W supplied by the water supply device 32 is, for example, 20 to 95° C., preferably 30 to 80° C., and more preferably 40 to 70° C. The immersion time of the ground soybeans 11 is, for example, 1 minute to 3 hours, preferably 1 minute to 1 hour, and more preferably 1 minute to 30 minutes.

The immersion device 30 may be provided with the water adding device 34 for adding the water W according to the swelling speed of the ground soybeans 11. The water adding device 34 is, for example, a shower head, and supplies the water W to the immersion tank 60 such that the swelling speed of the ground soybeans 11 is maintained within a desired range. The temperature of the water W supplied by the water adding device 34 is, for example, 20 to 95° C., preferably 30 to 80° C., and more preferably 40 to 70° C. By setting the temperature of the water W within this temperature range, the effect of shortening the immersion time is exhibited by adding the high-temperature water W, and the effect of suppressing the swelling speed is exhibited by adding the low-temperature water W.

Note that the immersion device 30 of the present embodiment is relatively compact and performs immersion in a short period of time. Therefore, it is suitable for the ground soybeans 11 that can be immersed in a short period of time rather than whole soybeans that require a relatively long period of time for immersion.

In this manner, the ground soybeans 11 immersed in the water W while being conveyed in the immersion tank 60 become the swollen soybeans 17 which are at least partially swollen, and the swollen soybeans 17 are supplied through the discharge port 61d to the crushing device 9 together with the water W used for immersion. In the shown example, the swollen soybeans 17 and the water W are supplied to the crushing device 9 through the discharge port 61d via a slurry tank 67 with stirring. The reason for providing the slurry tank 67 with stirring is to prevent solid-liquid separation. Subsequent processes are as described above with reference to FIG. 1.

It is to be noted that the present invention is not limited to the above-described embodiments, and can be modified, improved, and the like as appropriate. In addition, the material, shape, size, numerical value, form, number, location, and the like of each component in the above-described embodiment are random and not limited as long as the present invention can be achieved.

Although various embodiments have been described above with reference to the drawings, it is needless to say that the present invention is not limited to such examples. It is obvious that those skilled in the art can conceive various modification examples or correction examples within the scope described in the claims, and it is understood that these also belong to the technical scope of the present invention. Moreover, each component in the above embodiments may be combined randomly without departing from the spirit of the invention.

In addition, this application is based on a Japanese patent application filed on Jun. 21, 2021 (Japanese patent application 2021-102657), a Japanese patent application filed on Dec. 1, 2021 (Japanese patent application 2021-195527), and a Japanese patent application filed on Jan. 31, 2022 (Japanese patent application 2022-013701), the contents of which are incorporated into this application by reference.

### REFERENCE SIGNS LIST

3 Washing/sterilization device
5 Grinding device
7 Peeling device
8 Slurry tank
9 Crushing device
10 Raw whole soybean
11 Ground soybean
12 Bean curd refuse
13 Seed coat
14 Soy milk
15 Hypocotyl
16 Tofu
17 Swollen soybean
19 Raw soybean paste
21 Soy milk production device
23 Squeezing device
25 Coagulation device
27 Forming device
30 Immersion device
31 Hopper
32 Water supply device
33 Pipe (conveyance channel)
33a Cylinder unit
33b Connection unit
33c Folded portion
33d Inlet
33e Outlet
34 Water adding device
35 Pump
35a Piston
36 Block
36a Inclined pipe
36b Folded portion
36c Connecting pipe
37 Air blower
38 Heating device
39 Static mixer
40 Trough/screw device
41 Trough (conveyance channel)
42 Rotating shaft
43 Screw
43B Bottom portion
43O Center
43P Middle portion
45 Pump
46 Air blower
47 Return channel
48 Pump
49 Water supply device
50 Immersion tank
51a First roller
51b Second roller
53 Belt member
53a Outer circumferential surface
55 Wall member
57 Housing
57a Inner circumferential surface
57b Input port
57c Discharge port
57d Opening
59 Seal member
60 Immersion tank
61 Housing
61a Bottom surface
61b Opening
61c Inner circumferential surface
61d Discharge port
63 Shaft member
65 Wall member
67 Slurry tank
71 Jacket
72 Shaft
73 Gear
80 Soybean heating conveyance device
81 Trough
82 Rotating shaft
83 Screw

1. A tofu product production device comprising:
a grinding device that grinds raw soybeans to obtain ground soybeans;
an immersion device that immerses the ground soybeans in water to obtain swollen soybeans swollen to at least 1.2 to 2.4 times; and
a crushing device that crushes the swollen soybeans to obtain raw soybean paste, wherein
the ground soybeans are immersed for a short period of time in the immersion device.

2. The tofu product production device according to claim 1, wherein
the grinding device is provided with one or more water adding devices for grinding the raw soybeans while water is added.

3. The tofu product production device according to claim 1, wherein
the immersion device is provided with at least one water adding device that adds water according to a swelling speed of the ground soybeans.

4. The tofu product production device according to claim 1, wherein
the immersion device has a conveyance channel for conveying the ground soybeans while the ground soybeans are immersed in water, and
a cross-sectional area of the conveyance channel increases in accordance with volumetric expansion due to swelling of the ground soybeans.

5. The tofu product production device according to claim 1, wherein
the immersion device has a conveyance channel for conveying the ground soybeans while the ground soybeans are immersed in water, and
the conveyance channel conveys the ground soybeans from a lower part to an upper part in a direction of gravity.

6. The tofu product production device according to claim 1, wherein
the immersion device includes
a pipe configuring a conveyance channel for conveying the ground soybeans while the ground soybeans are immersed in water, and
a pump that supplies the ground soybeans and the water toward the pipe.

7. The tofu product production device according to claim 6, wherein
the pipe is formed such that the ground soybean is directed from the lower part to the upper part in the direction of gravity.

8. The tofu product production device according to claim 6, wherein
the pipe has a folded portion with an angle of 180 degrees or less.

9. The tofu product production device according to claim 8, wherein
the folded portion of the pipe is provided with an air blower that blows air toward an inside of the pipe.

10. The tofu product production device according to claim 6, wherein
the pipe is provided with a heating device that heats the water.

11. The tofu product production device according to claim 6, wherein
a static mixer is provided in the pipe.

12. The tofu product production device according to claim 1, wherein
the immersion device includes
a trough configuring a conveyance channel for conveying the ground soybeans while the ground soybeans are immersed in water, and
a screw provided inside the trough, and
the ground soybeans and water supplied into the trough travel through the inside of the trough as the screw rotates.

13. The tofu product production device according to claim 12, wherein
the trough is formed such that the ground soybean is directed from the lower part to the upper part in the direction of gravity.

14. The tofu product production device according to claim 12, wherein
one or a plurality of the screws are provided inside the trough.

15. The tofu product production device according to claim 12, wherein
the immersion device includes a plurality of trough/screw devices each having the trough and the screw,
the plurality of trough/screw devices are provided in multiple stages in an up-down direction in the direction of gravity, and
the ground soybeans and water are conveyed from the trough/screw device in a lower stage to the trough/screw device in an upper stage.

16. The tofu product production device according to claim 12, wherein
the immersion device includes an air blowing device that blows off the ground soybeans adhering to the screw with air.

17. The tofu product production device according to claim 12, further comprising:
a rotary positive displacement single shaft eccentric screw pump to which the ground soybeans obtained by the grinding device and water are supplied, wherein
the rotary positive displacement single shaft eccentric screw pump supplies the ground soybeans and the water to the immersion device while mixing the ground soybeans and the water.

18. The tofu product production device according to claim 1, wherein
the immersion device is a batch type continuous immersion device having a plurality of immersion tanks for immersing the ground soybeans in water.

19. The tofu product production device according to claim 18, wherein
the immersion device includes
a housing, and
a plurality of wall members spaced apart from each other within the housing,
the plurality of immersion tanks are formed between the wall members adjacent to each other, and
the plurality of immersion tanks immerse the ground soybeans in water while conveying the ground soybeans as the plurality of wall members move.

20. A tofu product production method comprising:
a grinding process of grinding raw soybeans to obtain ground soybeans;
an immersion process of immersing the ground soybeans in water to obtain swollen soybeans swollen to at least 1.2 to 2.4 times; and
a crushing process of crushing the swollen soybeans to obtain raw soybean paste, wherein
the ground soybeans are immersed for a short period of time in the immersion process.

21. The tofu product production method according to claim 20, wherein
in the grinding process, the raw soybeans are ground while water is added.

22. The tofu product production method according to claim 20, wherein
as the raw soybeans, those that are washed or sterilized, or those that pass through a washing/sterilization device are used.

23. The tofu product production method according to claim 20, wherein
as the raw soybeans, those in a wet surface state are used.

24. The tofu product production method according to claim 20, wherein
all or part of seed coats generated when the raw soybeans are ground in the grinding process are used.
